(19) United States
(12) Patent Application Publication
(10) Pub. No.: US 2010/0265353 A1
(43) Pub. Date: Oct. 21, 2010

(54) Image Processing Device, Image Sensing Device And Image Reproduction Device

(75) Inventors: Kanichi KOYAMA, Higashiosaka City (JP); Yukio MORI, Hirakata City (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/761,655

(22) Filed: Apr. 16, 2010

(30) Foreign Application Priority Data
Apr. 16, 2009 (JP) 2009-099535
Apr. 1, 2010 (JP) 2010-085177

(51) Int. Cl. G06K 9/46; G06K 9/36; G06K 9/34; H04N 5/228

(52) U.S. Cl. 348/222.1; 382/195; 382/284; 382/173; 348/E05.031

(57) ABSTRACT

There is provided an image processing device which uses a main image and a sub-image shot at different times to generate an output image. The image processing device includes a subject detection portion which detects a specific subject from each of the main image and the sub-image and detects the position and the size of the specific subject on the main image and the position and the size of the specific subject on the sub-image, and generates the output image by causing the main image to be blurred based on a variation in the position of and a variation in the size of the specific subject between the main image and the sub-image.

This nonprovisional application claims priority under 35 U.S.C. §119(a) on Patent Application No. 2009-099535 filed in Japan on Apr. 16, 2009 and on Patent Application No. 2010-085177 filed in Japan on Apr. 1, 2010, the entire contents of which are hereby incorporated by reference.

### BACKGROUND OF THE INVENTION

1. Field of the Invention

The present invention relates to an image processing device that performs image processing on images. The invention also relates to an image sensing device and an image reproduction device that utilize the image processing device.

2. Description of Related Art

When a vehicle or the like running in a car race or the like is shot, there is a special shooting technique commonly called a “follow shot” that is used to emphasize the sense of speed. Conventionally, the follow shot is achieved by shooting an image while an image sensing device is moved sideway according to the speed of a moving object such as a vehicle so as to follow the moving object. The camera operation of moving the image sensing device sideway so as to follow the moving object requires experience and a skill comparable to that of a professional photographer. Thus, it is difficult for a general user to properly obtain the effects of the follow shot.

One conventional way to solve this problem is to detect the movement of an object moving sideway and shift the optical axis according to the result of the detection so as to follow the object. Thus, it is possible to easily obtain a powerful image in which the object moving sideway is in focus and the background is so blurred as to appear to flow.

Incidentally, the follow shot described above is a follow shot that is achieved by focusing on an object moving sideway with respect to an image sensing device. For convenience, this follow shot is called a lateral follow shot. There is another follow shot called a vertical follow shot. The vertical follow shot is a follow shot that is used to focus on either an object moving close to an image sensing device or an object moving away from the image sensing device.

A conventional vertical follow shot is achieved by varying an optical zoom magnification during exposure such that a moving object is kept in focus. In order to achieve such a vertical follow shot, an extremely advanced shooting technique is required, and equipment for the shooting is not widely available. It is thus impossible to achieve the vertical follow shot by the conventional method of shifting the optical axis.

### SUMMARY OF THE INVENTION

According to one aspect of the present invention, there is provided an image processing device which uses a main image and a sub-image shot at different times to generate an output image, the image processing device including a subject detection portion which detects a specific subject from each of the main image and the sub-image and detects the position and the size of the specific subject on the main image and the position and the size of the specific subject on the sub-image. The image processing device generates the output image by causing the main image to be blurred based on a variation in the position of and a variation in the size of the specific subject between the main image and the sub-image.

According to another aspect of the present invention, there is provided an image processing device which causes an input image to be blurred to generate an output image, the image processing device including: a scaling portion which performs scaling using a plurality of enlargement factors or a plurality of reduction factors on the input image to generate a plurality of scaled images; and an image combination portion which combines the plurality of scaled images, and applies the result of the combination to the input image to generate the blurring.

According to yet another aspect of the present invention, there is provided an image processing device which causes an input image to be blurred to generate an output image, the image processing device including: an image deterioration function deriving portion which divides a background region of the input image into a plurality of small blocks, and derives, for each of the small blocks, an image deterioration function that causes an image within the small block to be blurred; and a filtering processing portion which performs, for each of the small blocks, filtering on the image within the small block according to the image deterioration function to generate the output image. In the image processing device, the entire image region of the input image is composed of the background region and a reference region, and the image deterioration function for each of the small blocks corresponds to an image deterioration vector whose direction intersects a position of the reference region and the small block.

According to another aspect of the present invention, there is provided an image sensing device including: any one of the image processing devices described above; and an image sensing portion which shoots the main image and the sub-image or the input image that is fed to the image processing device.

According to another aspect of the present invention, there is provided an image reproduction device including: any one of the image processing devices described above; and a display portion which displays the output image generated by the image processing device.

The meanings and the effects of the present invention will become more apparent from the following description of embodiments. However, the following embodiments are simply an example of embodiments of the present invention; the present invention and the meanings of the terms of constituent components are not limited to the embodiments below.

### BRIEF DESCRIPTION OF THE DRAWINGS

FIG. 1 is an overall block diagram of an image sensing device according to a first embodiment of the present invention;

FIG. 2 is a block diagram of a portion, according to the first embodiment of the invention, that is included in the image sensing device of FIG. 1 and that performs image processing;

FIG. 3 is a diagram showing four frame images and tracked target regions in the frame images;

FIG. 4 is a diagram showing a process of generating an output blurred image according to the first embodiment of the invention;

FIG. 5 is a diagram showing an example of a frame image from which the output blurred image is generated;

FIGS. 6A to 6C are diagrams showing scaled images obtained by performing enlargement scaling on the frame image of FIG. 5;

FIG. 7 is a diagram showing an intermediate combined image obtained by combining the three scaled images shown in FIGS. 6A to 6C;

FIG. 8 is a diagram showing an output blurred image based on the frame image of FIG. 5 and the intermediate combined image of FIG. 7;

FIG. 9 is a flowchart of an operation of generating the output blurred image in a shooting mode in the first embodiment of the invention;

FIG. 10 is a flowchart of a modified operation in the shooting mode in the first embodiment of the invention;

FIG. 11 is a flowchart of an operation of generating the output blurred image in a reproduction mode in the first embodiment of the invention;

FIG. 12 is a block diagram of a portion, according to a second embodiment of the invention, that is included in the image sensing device of FIG. 1 and that performs the image processing;

FIG. 13 is a diagram showing how an image region of an image to be computed is divided into a plurality of small blocks in the second embodiment of the invention;

FIGS. 14A and 14B are diagrams showing coordinate values of the position of a tracked target region in the second embodiment of the invention;

FIG. 15 is a diagram showing the variation of the tracked target region between the adjacent frame images in the second embodiment of the invention;

FIG. 16 is a diagram showing how all the image region of the frame image is divided into four image regions in the second embodiment of the invention;

FIG. 17A is a diagram showing an image deterioration vector that is obtained when the tracked target moves close to the image sensing device in the second embodiment of the invention; FIG. 17B is a diagram showing an image deterioration vector that is obtained when the tracked target moves away from the image sensing device in the second embodiment of the invention;

FIG. 18 is a flowchart of an operation of generating the output blurred image in the shooting mode in the second embodiment of the invention;

FIG. 19 is a block diagram of a portion, according to a fourth embodiment of the invention, that is included in the image sensing device of FIG. 1 and that performs the image processing;

FIG. 20 is a flowchart of an operation of generating the output blurred image in the fourth embodiment of the invention;

FIG. 21 is a diagram showing how a blurring reference region is set on a target input image according to the fourth embodiment of the invention;

FIG. 22 is a diagram showing a process of generating the output blurred image according to the forth embodiment of the invention;

FIG. 23 is a block diagram of a portion, according to a fifth embodiment of the invention, that is included in the image sensing device of FIG. 1 and that performs the image processing;

FIG. 24 is a diagram showing the direction in which the image deterioration vector points in the fifth embodiment of the invention; and

FIG. 25 is a flowchart of an operation of generating the output blurred image in the fifth embodiment of the invention.

### DETAILED DESCRIPTION OF PREFERRED EMBODIMENTS

Several embodiments of the present invention will be specifically described below with reference to the accompanying drawings. In the referenced drawings, like parts are identified with like symbols, and their description will not be basically repeated.

### First Embodiment

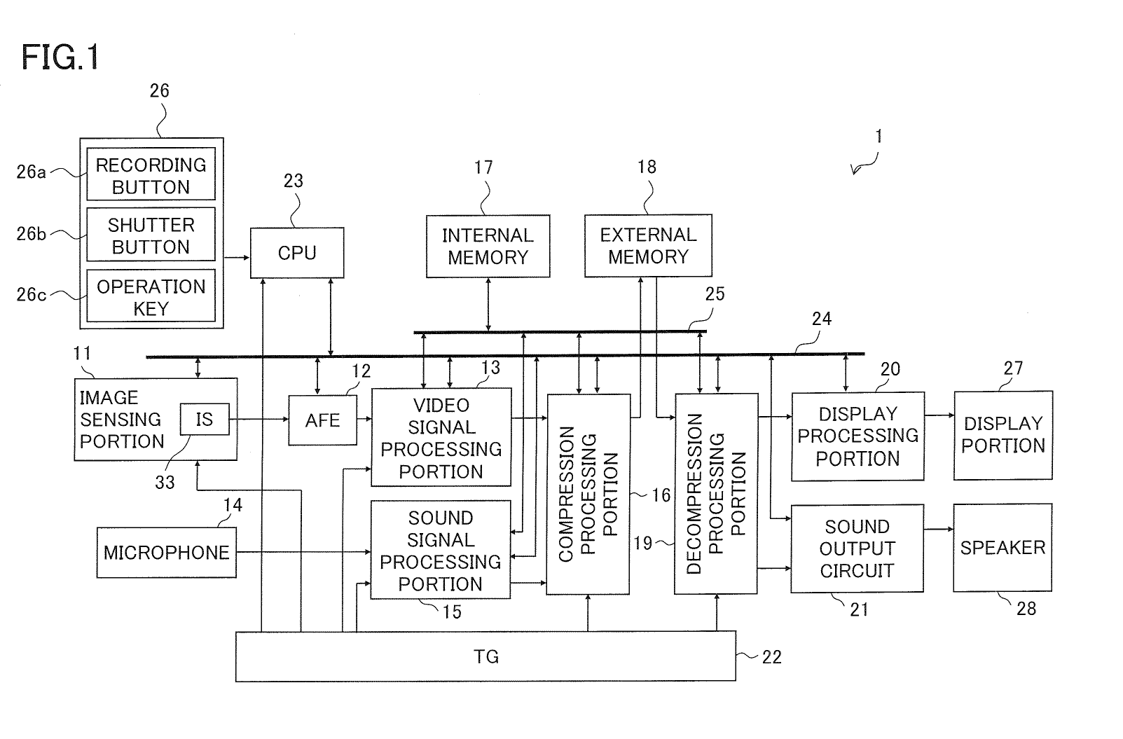

The first embodiment of the present invention will be described. FIG. 1 is an overall block diagram of an image sensing device 1 according to the first embodiment. The image sensing device 1 includes individual portions represented by symbols 11 to 28. The image sensing device 1 is a digital video camera, and can shoot not only a moving image or a still image but also a still image during the shooting of a moving image. The image sensing device 1 may be a digital still camera that can shoot only a still image. The individual portions within the image sensing device 1 exchange signals (data) with each other through a bus 24 or a bus 25. A display portion 27 and/or a speaker 28 may be provided in an external device (not shown) of the image sensing device 1.

An image sensing portion 11 includes an image sensor 33, an unillustrated optical system, an aperture and a driver. The image sensor 33 is formed by arranging a plurality of light receiving pixels in horizontal and vertical directions. The image sensor 33 is a solid-state image sensor that is formed with a CCD (charge coupled device) or CMOS (complementary metal oxide semiconductor) image sensor or the like. The light receiving pixels of the image sensor 33 photoelectrically convert an optical image of a subject received through the optical system and the aperture, and outputs electrical signals resulting from the photoelectrical conversion to an AFE 12 (analog front end). The lenses of the optical system form the optical image of the subject onto the image sensor 33.

The AFE 12 amplifies an analog signal output from the image sensor 33 (light receiving pixels), converts the amplified analog signal into a digital signal and then outputs it to a video signal processing portion 13. The amplification factor of the signal amplification by the AFE 12 is controlled by a CPU (central processing unit) 23. The video signal processing portion 13 performs necessary image processing on an image represented by the signal output from the AFE 12, and generates a video signal on an image resulting from the image processing. A microphone 14 converts sound around the image sensing device 1 into an analog sound signal; a sound signal processing portion 15 converts the analog sound signal into a digital sound signal.

A compression processing portion 16 compresses the video signal from the video signal processing portion 13 and the sound signal from the sound signal processing portion 15 with a predetermined compression method. An internal memory 17 is formed with a DRAM (dynamic random access memory) or the like, and temporarily stores various types of data. An external memory 18 serving as a recoding medium is a nonvolatile memory such as a semiconductor memory or a magnetic disk, and records the video signal and sound signal compressed by the compression processing portion 16.

A decompression processing portion 19 decompress the compressed video signal and sound signal read from the external memory 18. Either the video signal decompressed by the decompression processing portion 19 or the video signal from the video signal processing portion 13 is fed through a display processing portion 20 to the display portion 27 formed with a liquid crystal display or the like, and is displayed as an image. The sound signal decompressed by the decompression processing portion 19 is fed to the speaker 28 through a sound output circuit 21 and is output as sound.

A TG (timing generator) 22 generates a timing control signal for controlling the timing of each operation in the entire image sensing device 1, and feeds the generated timing control signal to the individual portions of the image sensing device 1. The timing control signal contains a vertical synchronization signal Vsync and a horizontal synchronization signal Hsync. The CPU 23 collectively controls the operations of the individual portions of the image sensing device 1. An operation portion 26 includes: a recording button 26a for providing an instruction to start or stop the shooting and recording of a moving image; a shutter button 26b for providing an instruction to shoot and record a still image; an operation key 26c; and the like. The operation portion 26 receives various types of operations performed by a user. Information on the operation performed on the operation portion 26 is transmitted to the CPU 23.

The operation mode of the image sensing device 1 includes a shooting mode in which it is possible to shoot and record an image (still image or moving image) and a reproduction mode in which an image (still image or moving image) recorded in the external memory 18 is reproduced and displayed on the display portion 27. The operation mode is switched between the individual modes according to an operation performed on the operation key 26c.

In the shooting mode, the subject is periodically shot every predetermined frame period, and images formed by shooting the subject are sequentially acquired. A digital video signal representing an image is also called image data. Image data for a pixel may also be called a pixel signal. The pixel signal, for example, includes a brightness signal and a color-difference signal. Image data obtained for one frame period represents an image per sheet. The per-sheet image represented by the image data obtained for one frame period is also called a frame image. In this specification, the image data may be simply referred to an image.

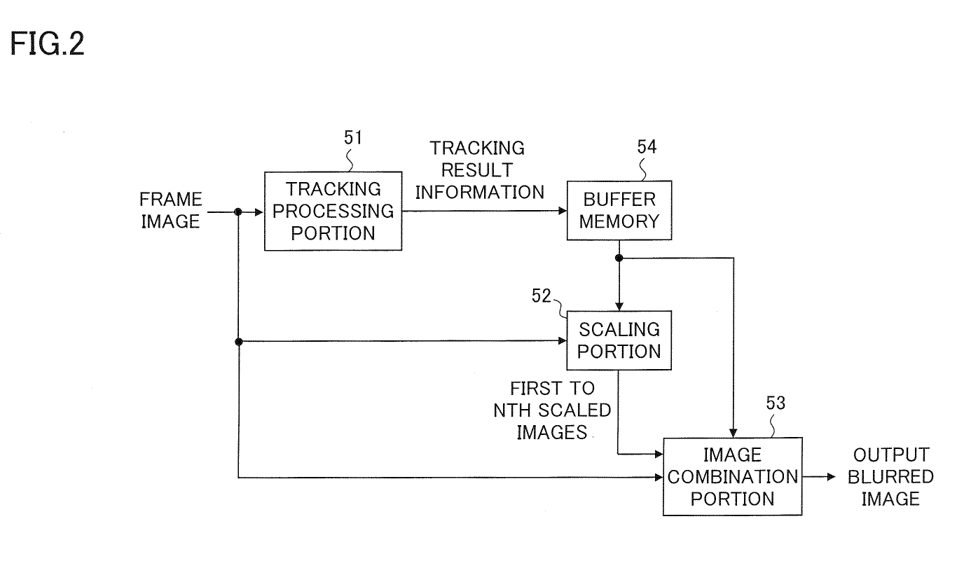

The image sensing device 1 has the function of performing image processing to generate an image similar to an image obtained by the vertical follow shot described previously. As already described, the vertical follow shot is a follow shot that is used to focus on either an object moving close to the image sensing device 1 or an object moving away from the image sensing device 1. Since the above-mentioned image processing is performed to deliberately blur part of an image, an image generated by this function is called an output blurred image. In FIG. 2, a block diagram of a portion for performing this function is shown. A tracking processing portion 51, a scaling portion 52 and an image combination portion 53 shown in FIG. 2 can be provided in the video signal processing portion 13 of FIG. 1. A buffer memory 54 of FIG. 2 can be provided in the internal memory 17 of FIG. 1.

The tracking processing portion 51 performs tracking processing for tracking, on a frame image sequence, a subject of interest included in the subjects of the image sensing device 1. The frame image sequence refers to a sequence of frame images that are obtained by periodically shooting an image every frame period and that are arranged in chronological order. The subject of interest that is tracked in the tracking processing is hereinafter called a tracked target. The subjects other than the tracked target (for example, stationary bodies such as a ground and a building) are called a background.

In the tracking processing, based on the image data of the frame image sequence, the position and the size of a tracked target in each frame image are detected in a sequential manner. Among a plurality of frame images that constitute the frame image sequence, the tracking processing portion 51 first regards any one of the frame images as an initial frame image, and detects the position and the size of the tracked target in the initial frame image based on the image data of the initial frame image.

The tracked target can be set based on the image data of the initial frame image. For example, a moving object is detected with a plurality of frame images including the initial frame image either based on a background differencing method (background subtraction method) or based on an inter-frame differencing method (frame subtraction method), and thus the moving object on the frame image sequence is detected, with the result that the moving object is set as the tracked target. Alternatively, for example, based on the image data of the initial frame image, the face of a person in the initial frame image is detected, and the person is set as the tracked target using the result of the detection of the face.

The tracked target can also be set according to an instruction of the user. For example, with the initial frame image being displayed on the display portion 27, a display region where a subject necessary to be the tracked target is displayed is specified by the user, and thus it is possible to set the tracked target according to the specified display region.

In a frame image of interest, an image region where image data representing the tracked target is present is called a tracked target region (subject region), and image regions (that is, image regions where image data representing the background is present) other than the tracked target region are called a background region. Hence, all the image regions (in other words, the entire image region) in the frame image of interest are classified into the tracked target region and the background region. The tracked target region is set to include the tracked target and is also set as small as possible. The detection of the position and the size of the tracked target region in the frame image of interest has the same meaning as the detection of the position and the size of the tracked target in the frame image of interest. The position of the tracked target region to be detected includes the center position of the tracked target region. It can be considered that, in each frame image, the center position of the tracked target region represents the position of the tracked target, and that the size of the tracked target region represents the size of the tracked target.

After the detection of the position and the size of the tracked target in the initial frame image, the tracking processing portion 51 regards frame images shot after the shooting of the initial frame image as the tracked target frame images, and detects, based on the image data of the tracked target frame images, the position and the size of the tracked target in each tracked target frame image (that is, detects the center position and the size of the tracked target region in each tracked target frame image).

In the following description, unless otherwise specified, the frame image indicates the initial frame image or the tracked target frame image from which the position and the size of the tracked target is detected. The tracked target region of any shape can be used; in the following description, the tracked target region is assumed to be rectangular.

The tracking processing between the first and second frame images can be performed as follows. Here, the first frame image refers to a frame image where the position and the size of the tracked target have already been detected, and the second frame image refers to a frame image where the position and the size of the tracked target will need to be detected. The shooting of the second frame image succeeds the shooting of the first frame image.

For example, the tracking processing portion 51 can perform the tracking processing based on an image feature included in the tracked target. The image feature includes brightness information and color information. Specifically, for example, a tracking frame that is estimated to be approximately as large as the tracked target region is set within the second frame image; the similarity between the image feature of an image within the tracking frame in the second frame image and the image feature of an image within the tracked target region in the first frame image is evaluated while the position of the tracking frame is sequentially changed within a search region; and it is determined that the center position of the tracked target region of the second frame image is present in the center position of the tracking frame in which the maximum similarity is obtained. The search region in the second frame image is set with reference to the position of the tracked target in the first frame image. In general, the search region is set to be a rectangular region whose center is the position of the tracked target in the first frame image; the size of the search region (image size) is smaller than the size of the entire image region of the frame image.

The size of the tracked target on the frame image varies due to, for example, variations in the distance of an actual space between the tracked target and the image sensing device 1. Thus, it is necessary to appropriately change the size of the tracking frame according to the size of the tracked target on the frame image; this change is achieved by employing a subject size detection method used in a known tracking algorism. For example, in the frame image, the background is considered to appear at a point sufficiently far from a point where the tracked target is predicted to be present, and, based on the image features at the former point and the latter point, to which of the background and the tracked target each of the pixels arranged between the former point and the latter point belongs is determined and classified. The image feature includes brightness information and color information. The outline of the tracked target is estimated by this classification. The outline of the tracked target may be estimated by performing known outline extraction processing. Then, the size of the tracked target is estimated from the outline, and the size of the tracking frame is set according to the estimated size.

Since the size of the tracking frame represents the size of the image region serving as the tracked target region, the size of the tracked target in the frame image is detected by the setting of the size of the tracking frame (in other words, the size of the tracked target region is detected.) Hence, the tracking processing described above is performed, and thus the position and the size of the tracked target in each frame image are detected. A necessary piece of tracking result information including information representing the position and the size detected (in other words, information representing the position and the size of the tracked target region) is temporarily stored in the buffer memory 54. The tracking result information stored in the buffer memory 54 is fed, as necessary, to the scaling portion 52 and the image combination portion 53.

It is possible to employ, as the method of estimating the position and the size of the tracked target on the frame image, any method different from the method described above (for example, a method disclosed in JP-A-2004-94680 or a method disclosed in JP-A-2009-38777).

Based on the tracking result information, the scaling portion 52 performs scaling on the frame image of interest. Here, the scaling refers to a linear transformation for enlarging an image or a linear transformation for reducing an image. The linear transformation for enlarging an image is also commonly called a digital zoom. The scaling is realized by resampling using interpolation. Although a detailed description is given later, the scaling portion 52 performs scaling on the frame image of interest using n kinds of enlargement factors or n kinds of reduction factors, and thereby produces the first to nth scaled images. Here, n represents an integer of two or more.

In the following description, the scaling for enlarging an image is particularly called an enlargement scaling, and the scaling for reducing an image is particularly called a reduction scaling. In the enlargement scaling, the enlargement factor of an image in the horizontal direction is equal to the enlargement factor of the image in the vertical direction (specifically, the aspect ratio of the image remains the same even after the enlargement scaling.) This is true for the reduction scaling.

Based on the tracking result information, the image combination portion 53 combines the first to nth scaled images with the frame image of interest to generate the output blurred image.

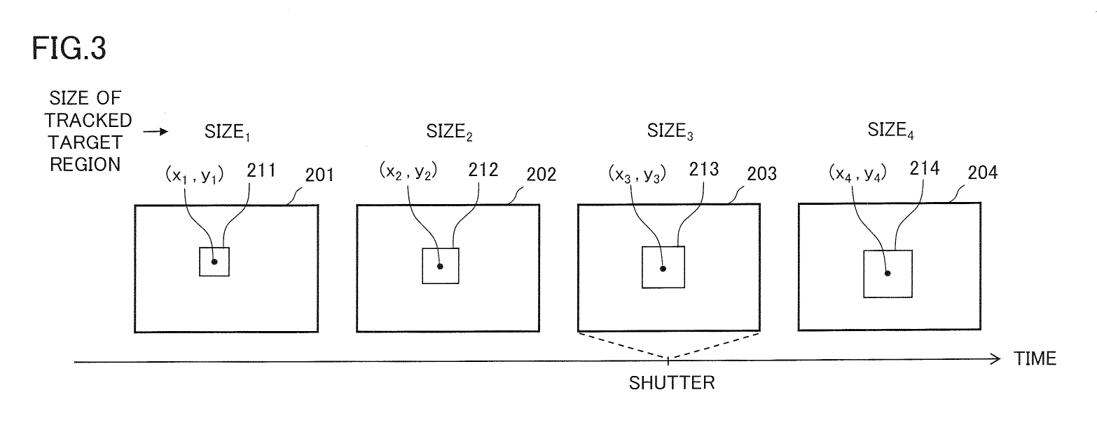

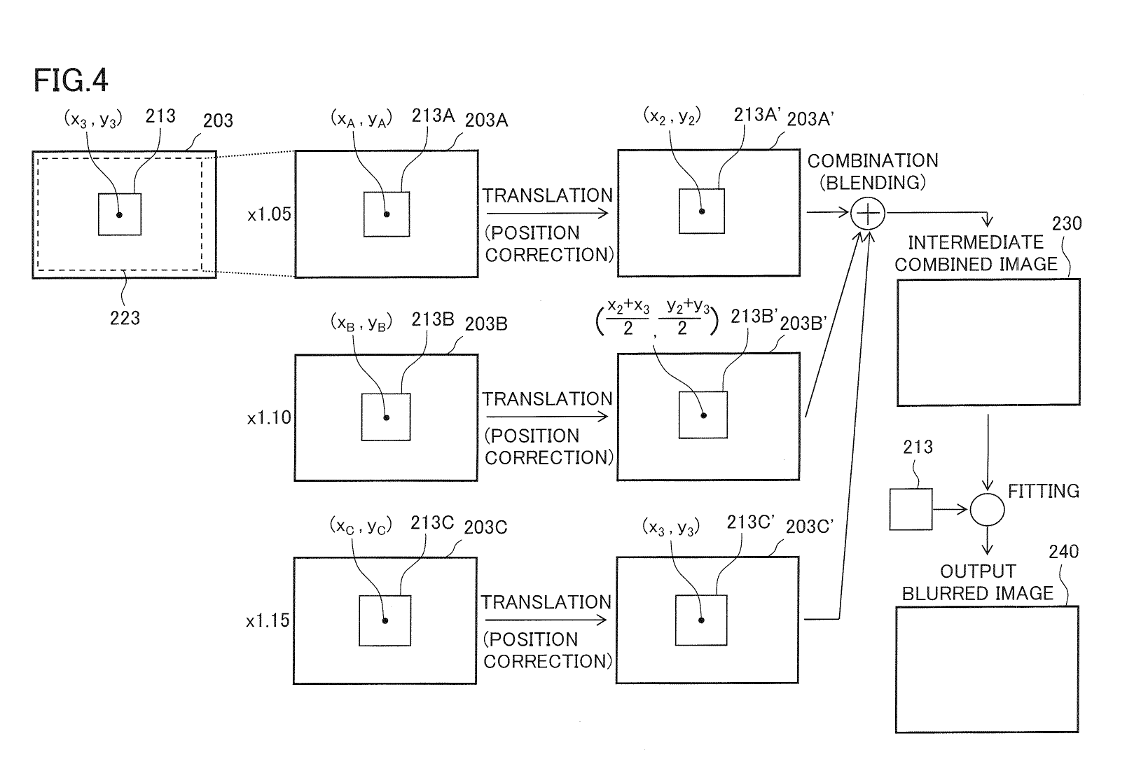

A specific method of generating the output blurred image will be described with reference to FIGS. 3 and 4. In the specific examples of FIGS. 3 and 4, the enlargement scaling is performed as the scaling. In the following description, symbols are given, and thus the names corresponding to the symbols may be omitted or represented by abbreviations. For example, when the symbol 201 represents a frame image, a frame image 201 and an image 201 represent the same thing. A position on a two-dimensional image is represented by coordinate values (x, y) on a two-dimensional coordinate system in which the two-dimensional image is defined. All images described in this specification are two-dimensional images unless otherwise specified. The letters x and y represent coordinate values in the horizontal direction and in the vertical direction, respectively, of the two-dimensional image. The size of the image region of interest such as the tracked target region is represented by, for example, the area of the image region of interest on the image.

Consider frame images 201 to 204 that are successively shot. The frame images 201, 202, 203 and 204 are assumed to be shot in this order. Hence, the image shot immediately before the image 203 is the image 202, and the image shot immediately after the image 203 is the image 204. The following is assumed: since the tracking processing is performed on a frame image sequence containing the frame images 201 to 204, tracked target regions 211 to 214 are extracted from the frame images 201 to 204, respectively, the center positions of the tracked target regions 211 to 214 are detected to be (x₁, y₁), (x₂, y₂), (x₃, y₃) and (x₄, y₄), respectively, and the sizes of the tracked target regions 211 to 214 are SIZE₁, SIZE₂, SIZE₃ and SIZE₄, respectively.

In the specific examples of FIGS. 3 and 4, since the tracked target moves close to the image sensing device 1 as time passes, an inequality “SIZE₁<SIZE₂<SIZE₃<SIZE₄” is assumed to hold true. In order to obtain the effects of the vertical follow shot in which the tracked target is kept in focus, the user is assumed to press down the shutter button 26b immediately before the frame image 203 is obtained. The operation of pressing down the shutter button 26b provides an instruction to shoot a still image. In this case, the frame image 203 is a still image that needs to be shot by the pressing down of the shutter button 26b. The still image that needs to be shot by the pressing down of the shutter button 26b is particularly called a reference image (main image). In this example, the frame image 203 is the reference image.

After the shooting of the frame image 203 or 204, the scaling portion 52 determines, based on information, included in the tracking result information, on the size of the tracked target region, the direction in which the size of the tracked target region is varied around the time of the shooting of the frame image 203. For example, when an inequality “SIZE₂<SIZE₃” holds true, the direction of the variation is determined to be the direction of increase; when an inequality “SIZE₂>SIZE₃” holds true, the direction of the variation is determined to be the direction of decrease. Alternatively, for example, when an inequality “SIZE₃<SIZE₄” holds true, the direction of the variation is determined to be the direction of increase; when an inequality “SIZE₃>SIZE₄” holds true, the direction of the variation is determined to be the direction of decrease. Based on the size of the tracked target region in three or more frame images, the direction of the variation may be determined.

The scaling portion 52 selects one of the enlargement scaling and the reduction scaling and performs it on the frame image 203. If the direction of the variation is determined to be the direction of increase, the enlargement scaling is performed on the frame image 203; if the direction of the variation is determined to be the direction of decrease, the reduction scaling is performed on the frame image 203. In the specific examples of FIGS. 3 and 4, since the direction of the variation is the direction of increase, the enlargement scaling is selected and performed on the frame image 203.

Based on the amount of variation in the size of the tracked target region around the time of the shooting of the reference image, the scaling portion 52 calculates an upper limit enlargement factor SA_{MAX} or a lower limit reduction factor SB_{MAX}. When the enlargement scaling is performed on the reference image, the upper limit enlargement factor SA_{MAX} is calculated; when the reduction scaling is performed on the reference image, the lower limit reduction factor SB_{MAX} is calculated. In the specific examples of FIGS. 3 and 4, since the enlargement scaling is performed on the frame image 203 that is the reference image, the upper limit reduction factor SA_{MAX} is calculated.

The upper limit enlargement factor SA_{MAX} is calculated according to an equation “SA_{MAX}=(SIZE₃/SIZE₂)×k” or an equation “SA_{MAX}=(SIZE₄/SIZE₃)×k”. The lower limit reduction factor SB_{MAX} calculated when the inequality “SIZE₂>SIZE₃” or the inequality “SIZE₃>SIZE₄” holds true is calculated according to an equation “SB_{MAX}=(SIZE₃/SIZE₂)×k” or an equation “SB_{MAX}=(SIZE₄/SIZE₃)×k”. Here, k represents a predetermined coefficient of one or more; for example, the coefficient is two. The upper limit enlargement factor SA_{MAX} or the lower limit reduction factor SB_{MAX} may be determined according to an instruction of the user through the operation portion 26 or the like.

After the calculation of the upper limit enlargement factor SA_{MAX}, the scaling portion 52 sets an enlargement factor larger than the equal scaling factor but equal to or less than the upper limit enlargement factor SA_{MAX} in 0.05 increments. For example, when the upper limit enlargement factor SA_{MAX} is 1.30, six enlargement factors are set, namely, 1.05, 1.10, 1.15, 1.20, 1.25 and 1.30. Since the reference image is scaled up by each of the set enlargement factors, the number of set enlargement factors is equal to the number of scaled images (that is, the value of n mentioned above) generated by the enlargement scaling. As the enlargement factor is larger, the degree of enlargement of an image by the enlargement scaling is increased.

Likewise, when the lower limit reduction factor SB_{MAX} is calculated, a plurality of reduction factors are set. Specifically, when the lower limit reduction factor SB_{MAX} is calculated, a reduction factor smaller than the equal scaling factor but equal to or more than the lower limit reduction factor SB_{MAX} is set in 0.05 increments. For example, when the lower limit reduction factor SB_{MAX} is 0.80, four reduction factors are set, namely, 0.95, 0.90, 0.85 and 0.80. As the reduction factor is smaller, the degree of reduction of an image by the reduction scaling is increased.

Here, for specific description, the upper limit enlargement factor SA_{MAX} is assumed to be equal to or more than 1.15 but less than 1.20. In this case, the scaling portion 52 sets three enlargement factors, namely, 1.05, 1.10 and 1.15. Then, as shown in FIG. 4, the frame image 203 is scaled up by an enlargement factor of 1.05, and thus a scaled image 203A is generated; the frame image 203 is scaled up by an enlargement factor of 1.10, and thus a scaled image 203B is generated; and the frame image 203 is scaled up by an enlargement factor of 1.15, and thus a scaled image 203C is generated.

The enlargement scaling is performed such that the size of an image (that is, the number of pixels in the horizontal and vertical directions) which has not been subjected to the enlargement scaling is the same as the size of the image which has undergone it and that the center position of the tracked target region on the scaled image coincides with the center position of the scaled image (this is true for the reduction scaling.)

Specifically, the scaled images 203A to 203C are generated as follows (see FIG. 4). A rectangular extraction frame 223 having a position (x₃, y₃) as its center position is set within the frame image 203, and an image within the extraction frame 223 is scaled up by an enlargement factor of 1.05, with the result that the scaled image 203A is generated. The size of the extraction frame 223 used when the scaled image 203A is generated is (1/1.05) times that of the frame image 203 in each of the horizontal and vertical directions. The scaled images 203B and 203C are generated by scaling up the image within the extraction frame 223 by enlargement factors of 1.10 and 1.15, respectively. The size of the extraction frame 223 used when the scaled image 203B is generated is (1/1.10) times that of the frame image 203 in each of the horizontal and vertical directions; the size of the extraction frame 223 used when the scaled image 203C is generated is (1/1.15) times that of the frame image 203 in each of the horizontal and vertical directions.

In FIG. 4, rectangular regions 213A, 213B and 213C represent the tracked target regions of the scaled images 203A, 203B and 203C, respectively, and positions (x_{A}, y_{A}), (x_{B}, y_{B}) and (x_{C}, y_{C}) represent the center positions of the tracked target regions 213A, 213B and 213C, respectively.

The n scaled images generated by the scaling portion 52 are combined by the image combination portion 53. Before this combination, geometrical transformation is performed on the scaled images to translate the scaled images. This geometrical transformation is called position correction. The position correction may be performed by the scaling portion 52; in this embodiment, it is performed by the image combination portion 53.

The n scaled images are assumed to be composed of the first to nth scaled images; a scaled image obtained by performing the enlargement scaling using the ith enlargement factor is assumed to be the ith scaled image. Here, i represents an integer equal to or more than one but equal to or less than n, and the (i+1)th enlargement factor is larger than the ith enlargement factor. In the specific examples of FIGS. 3 and 4, the first, second and third enlargement factors are 1.05, 1.10 and 1.15, respectively.

The image combination portion 53 performs the position correction on the first and nth scaled images such that the center position of the tracked target region on the first scaled image coincides with the center position (x_{S}, y_{S}) of the tracked target region on the frame image shot immediately before the reference image and that the center position of the tracked target region on the nth scaled image coincides with the center position (x_{T}, y_{T}) of the tracked target region on the reference image.

The position correction is performed on the ith scaled image such that, as the variable i is increased from 1 to n, the center position of the tracked target region that has undergone the position correction is linearly changed from the position (x_{S}, y_{S}) to the position (x_{T}, y_{T}). Hence, the position correction is performed on the second to (n−1)th scaled images such that the center positions of the tracked target regions of the second, third, . . . , and (n−1)th scaled images coincide with positions (x_{S}+1×(x_{T}−x_{S})/(n−1), y_{S}+1×(y_{T}−y_{S})/(n−1)), (x_{S}+2×(x_{T}−x_{S})/(n−1), y_{S}+2×(y_{T}−y_{S})/(n−1)), . . . , and (x_{S}+(n−2)×(x_{T}−x_{S})/(n−1), y_{S}+(n−2)×(y_{T}−y_{S})/(n−1)), respectively.

In the specific examples of FIGS. 3 and 4, the positions (x_{S}, y_{S}) and (x_{T}, y_{T}) are the positions (x₂, y₂) and (x₃, y₃), respectively, and the first, second and third scaled images that have not been subjected to the position correction are the scaled images 203A, 203B and 203C, respectively. The first, second and third scaled images that have undergone the position correction are represented by symbols 203A′, 203B′ and 203C′, respectively. Hence, the position correction for translating a pixel at the position (x_{A}, y_{A}) to a pixel at the position (x₂, y₂) is performed on the image 203A, and thus the image 203A′ is obtained; the position correction for translating a pixel at the position (x_{B}, y_{B}) to a pixel at the position ((x₂+y₃)/2, (y₂+y₃)/2) is performed on the image 203B, and thus the image 203B′ is obtained; and the position correction for translating a pixel at the position (x_{C}, y_{C}) to a pixel at the position (x₃, y₃) is performed on the image 203C, and thus the image 203C′ is obtained. In FIG. 4, rectangular regions 213A′, 213B′ and 213C′ represent the tracked target regions of the scaled images 203A′, 203B′ and 203C′, respectively, that have undergone the position correction.

Although, in the examples described above, the geometrical transformation for the position correction is performed after the scaling, the geometrical transformation for the position correction is included in the linear transformation for the scaling, and thus the scaled images 203A′, 203B′ and 203C′ may be generated directly from the frame image 203.

The image combination portion 53 combines the first to nth scaled images that have undergone the position correction to generate an intermediate combined image. This combination is performed by mixing the pixel signals of pixels arranged in the same positions between the first to nth scaled images that have undergone the position correction. This type of combination is also generally called alpha blending.

In the specific examples of FIGS. 3 and 4, the scaled images 203A′, 203B′ and 203C′ are combined to form an intermediate combined image 230. A pixel signal at the position (x₃, y₃) in the intermediate combined image 230 is generated by simply averaging the pixel signals at the position (x₃, y₃) in the images 203A′, 203B′ and 203C′ or by weighted averaging them. The pixel signals at the positions other than the position (x₃, y₃) are also generated in the same manner.

Then, the image combination portion 53 fits and combines the image within the tracked target region 213 of the frame image 203 to and with the intermediate combined image 230, and thereby generates an output blurred image 240. This fitting and combination is performed with the center position (x₃, y₃) on the tracked target region 213 coinciding with the position (x₃, y₃) on the intermediate combined image 230, and an image whose center is the position (x₃, y₃) within the intermediate combined image 230 and which is part of the intermediate combined image 230 is replaced with the image within the tracked target region 213, with the result that the output blurred image 240 is generated. Hence, the image data at the position (x₃, y₃) of the frame image 203 is present at the position (x₃, y₃) of the output blurred image 240.

Depending on the position (x₃, y₃) of the tracked target region 213 on the frame image 203, part of the extraction frame 223 may extend off the outside frame of the frame image 203. In the image region of the part extending off it, image data based on the shooting is not present. Between the images 203A′ to 203C′ obtained by performing the position correction described above, pixels corresponding to one another may not be present. In an image region where pixels corresponding to one another are not present, it is impossible to perform the above-described mixing of the pixel signals. When the intermediate combined image is generated by mixing the pixel signals, it is possible to ignore an image region where image data is not present and an image region where pixels corresponding to one another between the scaled images are not present. In this case, the field of view in the intermediate combined image or the output blurred image is slightly smaller than that in the reference image.

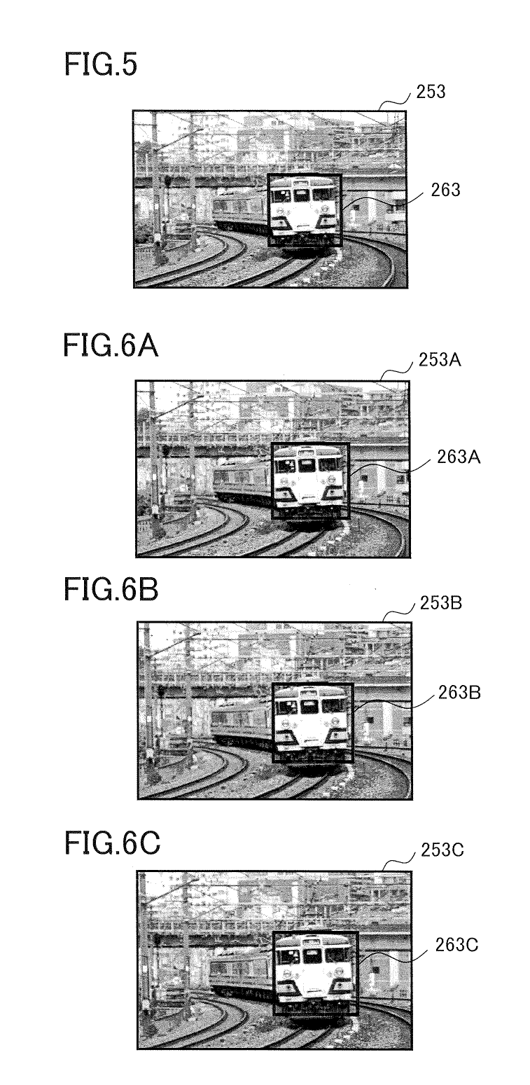

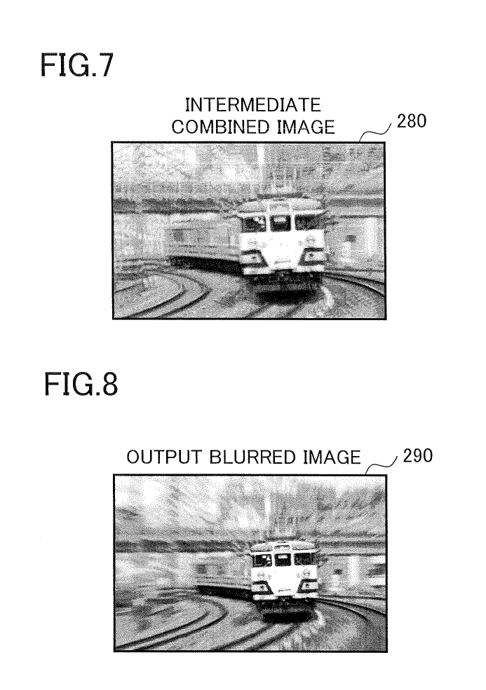

In FIGS. 5 to 8, an example of a group of images corresponding to FIGS. 3 and 4 is shown. An image 253 shown in FIG. 5 is an example of the frame image 203 serving as the reference image; images 253A to 253C shown in FIGS. 6A to 6C are examples of the scaled images 203A to 203C, respectively. In FIG. 5, a region within a rectangular 263 represents the tracked target region in the image 253. In FIGS. 6A to 6C, regions within rectangulars 263A to 263C represent the tracked target regions in the images 253A to 253C. An image 280 shown in FIG. 7 is an intermediate combined image based on the images 253A to 253C; an image 290 shown in FIG. 8 is an output blurred image based on the intermediate combined image 280 and the reference image 253.

Since a plurality of scaled images obtained by using a plurality of enlargement factors are combined, the intermediate combined image 280 is so blurred over the entire image region as to appear to flow from the center of the tracked target region to the outside. By fitting the unblurred image within the tracked target region 263 to the intermediate combined image 280, it is possible to obtain the powerful output blurred image 290 in which the background region is only blurred and the tracked target is in focus. The processing described above can also be described as follows. The result of the combination of the scaled images 253A to 253C is applied to the image within the background region of the reference image 253, and thus the image within the background region of the reference image 253 is so blurred as to appear to flow from the center of the tracked target region to the outside, with the result that the output blurred image 290 is generated.

Although the above description mainly deals with the operation performed when the enlargement scaling is carried out, a similar operation is performed when the reduction scaling is carried out. Specifically, when the reduction scaling is performed, the same position correction as described above is performed on the first to nth scaled images generated by the reduction scaling. However, when the reduction scaling is performed, a scaled image obtained by performing the reduction scaling using the ith reduction factor is assumed to be the ith scaled image. Here, i represents an integer equal to or more than one but equal to or less than n, and the (i+1)th reduction factor is smaller than the ith reduction factor. For example, when n=3, the first, second and third reduction factors are 0.95, 0.90 and 0.85, respectively. The image combination portion 53 combines the first to nth scaled images obtained by using the reduction scaling and the position correction to generate an intermediate combined image, and fits and combines the image within the tracked target region of the reference image to and with the intermediate combined image, with the result that the output blurred image is generated. The combination method for generating the intermediate combined image and the fitting/combination method are the same as described above.

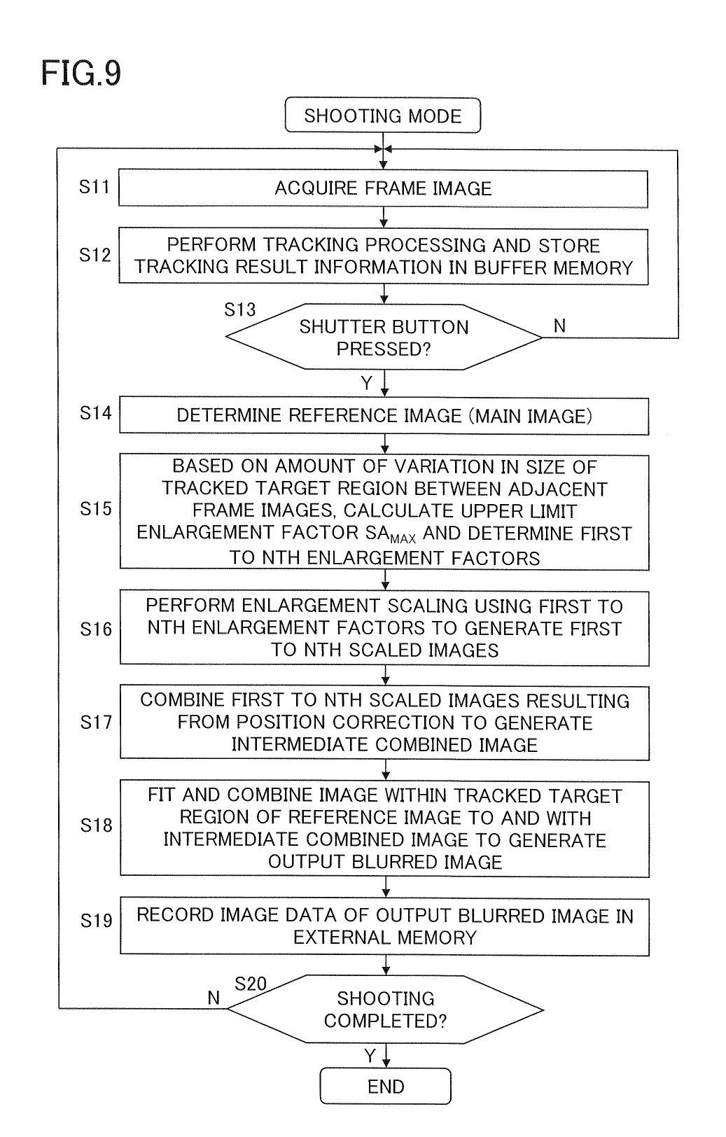

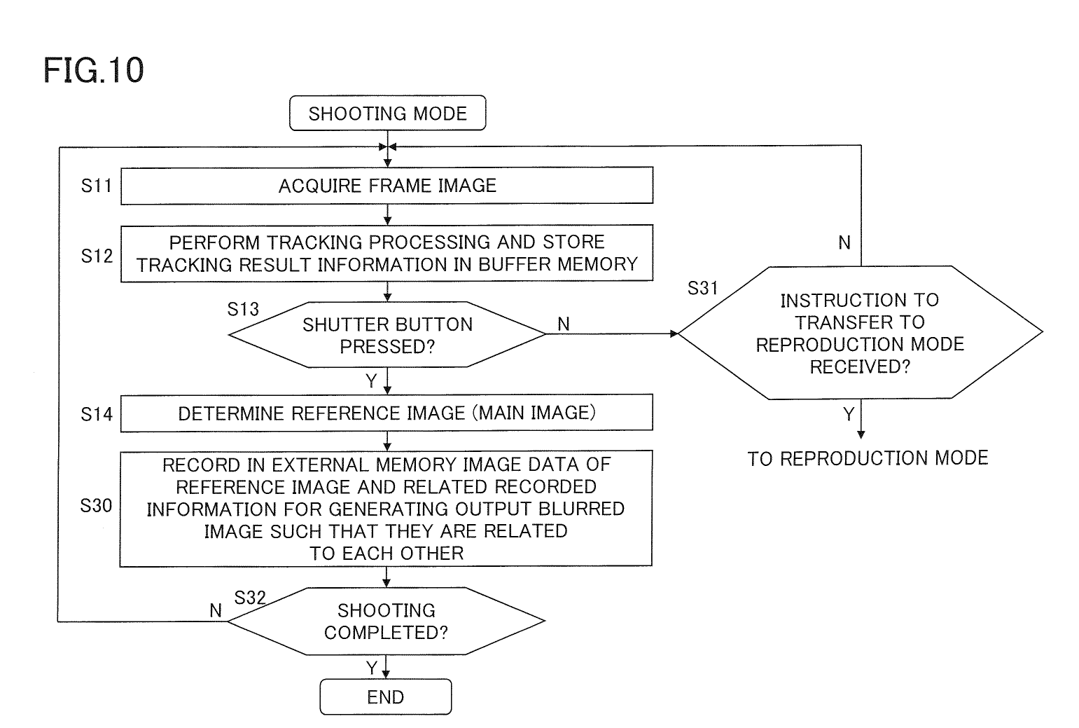

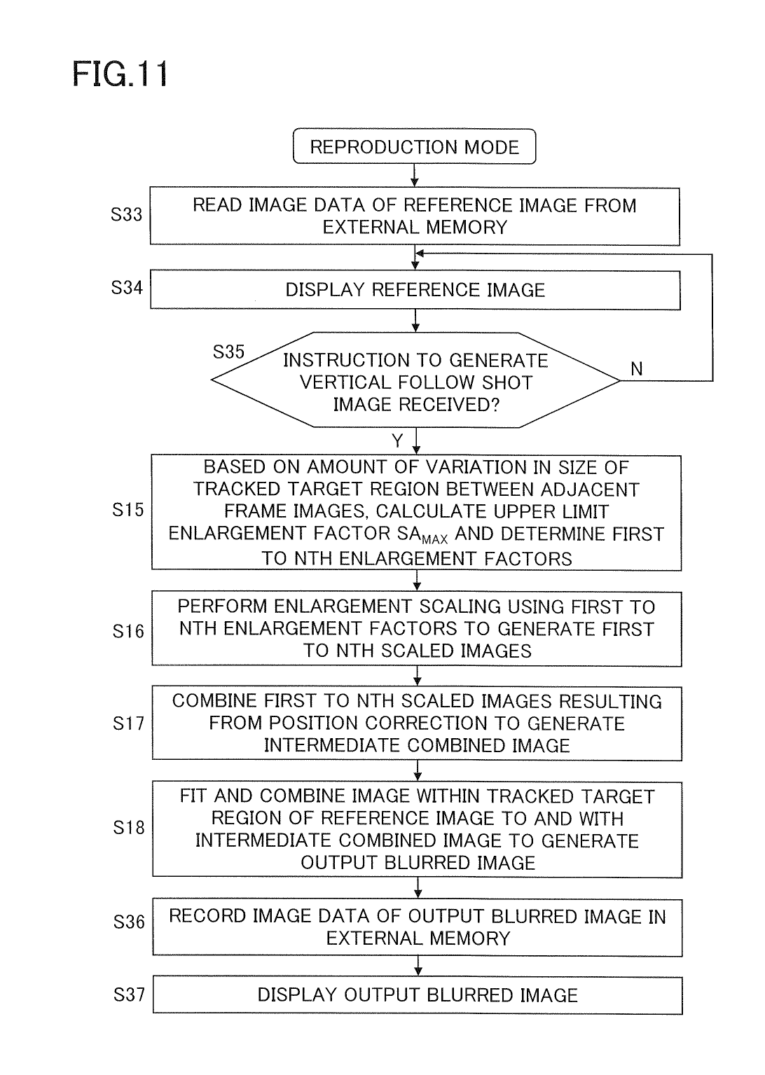

The flow of the operation of generating the output blurred image in the shooting mode will now be described with reference to FIG. 9. FIG. 9 is a flowchart showing the flow of the operation. The operation corresponding to the flowchart of FIG. 9 and operations corresponding to the flowcharts of FIGS. 10 and 11 as described later are performed on conditions that the enlargement scaling is performed as the scaling and that the upper limit enlargement factor SA_{MAX} is derived based on the tracking result information.

First, in step S11, the current frame image is shot by the image sensing portion 11 and is thereby acquired. Then, in step S12, the tracking processing is performed on the current frame image, and thus the tracking result information is obtained and stored (recorded) in the buffer memory 54. Thereafter, in step S13, the CPU 23 determines whether or not the shutter button 26b is pressed down. If the shutter button 26b is pressed down, the latest frame image obtained immediately after the pressing down of the shutter button 26b is determined to be the reference image (main image) (step S14), and thereafter processing in steps S15 to S20 is sequentially performed. On the other hand, if the shutter button 26b is not pressed down, the process returns to step S11, and the processing in steps S11 to S13 is repeatedly performed.

In step S15, the scaling portion 52 calculates the upper limit enlargement factor SA_{MAX} based on the amount of variation (corresponding to (SIZE₃/SIZE₂) or (SIZE₄ SIZE₃) in the example of FIG. 3) in the size of the tracked target region between the adjacent frame images including the reference image, and further sets the first to nth enlargement factors based on the upper limit enlargement factor SA_{MAX}. Then, in step S16, the enlargement scaling using the first to nth enlargement factors is performed on the reference image, and thus the first to nth scaled images are generated. The above-described position correction is performed on the obtained first to nth scaled images, and, in step S17, the image combination portion 53 combines the first to nth scaled images that have undergone the position correction to generate the intermediate combined image. Thereafter, in step S18, the image within the tracked target region of the reference image is fitted and combined to and with the intermediate combined image, and thus the output blurred image is generated.

In step S19, the image data of the generated output blurred image is recorded in the external memory 18. Here, the image data of the reference image may also be recorded in the external memory 18. After the recording of the image data, if an instruction to complete the shooting is provided, the operation of FIG. 9 is completed, whereas, if the instruction is not provided, the process returns to step S11, and the processing in step S11 and the subsequent steps is repeatedly performed (step S20).

Instead of generating the output blurred image in the shooting mode, it is possible to perform the image processing for generating the output blurred image in the reproduction mode. In this case, necessary data is recorded at the time of shooting according to the flowchart of FIG. 10, and the output blurred image is generated from the recorded data at the time of reproduction according to the flowchart of FIG. 11.

The operation in the shooting mode according to the flowchart of FIG. 10 will be described. The processing in steps S11 to S13 will first be sequentially performed. The processing is the same as described above.

If, in step S13, the shutter button 26b is pressed down, the latest frame image obtained immediately after the pressing down of the shutter button 26b is determined to be the reference image (main image) (step S14), and then the processing in step S30 is performed. On the other hand, if, in step S13, the shutter button 26b is not pressed down, in step S31, the CPU 23 determines whether or not an instruction to transfer to the reproduction mode is provided. The user can perform a predetermined operation on the operation portion 26 to provide the instruction to transfer thereto. If the instruction to transfer to the reproduction mode is provided, the operation mode of the image sensing device 1 is changed from the shooting mode to the reproduction mode, and then the processing in step S33 shown in FIG. 11 is performed. On the other hand, if the instruction to transfer to the reproduction mode is not provided, the process returns from step S31 to step S11, and the processing in steps S11 to S13 is repeatedly performed. An operation in the reproduction mode including the processing in step S33 shown in FIG. 11 will be described later, and the processing in step S30 will first be described.

In step S30, the image data of the reference image is recorded in the external memory 18. Here, necessary information (hereinafter, related recorded information) to generate the output blurred image from the reference image is also recorded such that the information is related to the image data of the reference image. The method of relating the information thereto is not limited. Preferably, for example, an image file having a main region and a header region is produced within the external memory 18, and the image data of the reference image is stored in the main region of the image file whereas the related recorded information is stored in the header region of the image file. Since the main region and the header region within the same image file are recording regions that are related to each other, this type of storage allows the image data of the reference image to be related to the related recorded information.

Information that needs to be included in the related recorded information is the tracking result information as to the frame image serving as the reference image and the frame images adjacent in time to the frame image serving as the reference image, which are stored in the buffer memory 54, or information based on the tracking result information described immediately above. When the reference image is the frame image 203 described above, for example, the tracking result information as to the frame images 202 and 203 is preferably included in the related recorded information.

After the recording processing in step S30, if the instruction to complete the shooting is provided, the operation shown in FIG. 10 is completed whereas, if the instruction is not provided, the process returns to step S11, and the processing in step S11 and the subsequent steps is repeatedly performed (step S32).

The operation in the reproduction mode according to the flowchart of FIG. 11 will be described. In step S33, to which the process transfers from step S31 of FIG. 10, the image data of the reference image is read from the external memory 18. The image data of the reference image read therefrom is fed to the scaling portion 52 and the image combination portion 53 shown in FIG. 2, and is also fed through the display processing portion 20 of FIG. 1 to the display portion 27, and, in step S34, the reference image is displayed on the display portion 27.

Thereafter, in step S35, the CPU 23 determines whether or not an instruction to generate a vertical follow shot image, which corresponds to the output blurred image, is provided. The user can perform a predetermined operation on the operation portion 26 to provide the instruction to generate the vertical follow shot image. If the instruction is not provided, the process returns to step S34 whereas, if the instruction is provided, the processing in steps S15 to S18 is sequentially performed.

The processing in steps S15 to S18 is the same as described above with reference to FIG. 9. However, the tracking result information necessary to perform processing in steps S15 to S18 in the reproduction mode is obtained from the related recorded information recorded in the external memory 18. Although, in the examples of the operation shown in FIGS. 10 and 11, in the reproduction mode, the upper limit enlargement factor SA_{MAX} is calculated and the first to nth enlargement factors are set, in step S30 of FIG. 10, the upper limit enlargement factor SA_{MAX} may be calculated and included in the related recorded information, or, in step S30 of FIG. 10, the first to nth enlargement factors may be set and included in the related recorded information.

The image data of the output blurred image generated in step S18 of FIG. 11 is recorded in the external memory 18 in step S36. In this case, the image data of the reference image is deleted, and the image data of the output blurred image may be recorded in the external memory 18. Alternatively, without the deletion described above, the image data of the output blurred image may be recorded in the external memory 18. The generated output blurred image is displayed on the display portion 27 (step S37). If the user performs an operation to change the upper limit enlargement factor SA_{MAX}, the output blurred image may be generated again using the upper limit enlargement factor SA_{MAX} that has been changed. Thus, the user can optimize, while checking the video, the effects of the vertical follow shot as desired by the user.

Although, in the examples of the operation shown in FIGS. 9 to 11, the upper limit enlargement factor SA_{MAX} is calculated based on the amount of variation in the size of the tracked target region, it is possible for the user to specify, as described above, the upper limit enlargement factor SA_{MAX}. Although, in the examples of the operation shown in FIGS. 9 to 11, the enlargement scaling is assumed to be performed as the scaling, the same operation is performed when the reduction scaling is carried out.

According to this embodiment, it is possible to easily obtain a powerful image having the effects of a vertical follow shot without the need for special shooting techniques and special equipment.

### Second Embodiment

An image sensing device according to a second embodiment of the present invention will be described. The overall configuration of the image sensing device of the second embodiment is similar to that shown in FIG. 1. Thus, the image sensing device of the second embodiment is also represented by the symbol 1. The second embodiment corresponds to a variation of the first embodiment. The description of the first embodiment is also applied to what is not particularly included in the description of the second embodiment.

In the second embodiment, instead of combining a plurality of scaled images, filtering is performed on the reference image according to variations in the size and the position of the tracked target region, and thus the background region is blurred.

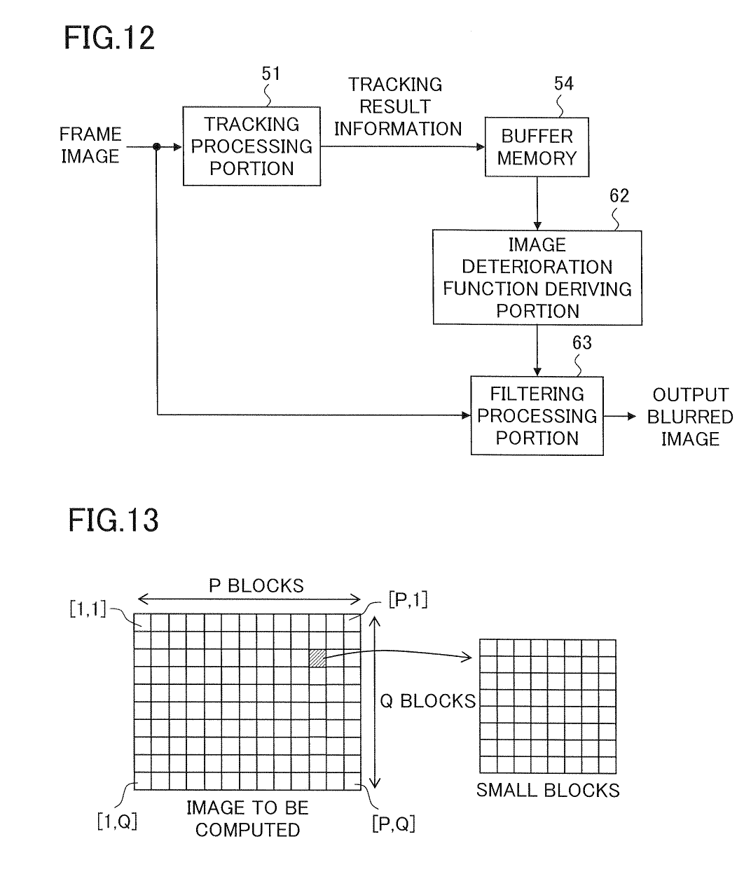

In FIG. 12, a block diagram of a portion for generating an output blurred image in the second embodiment is shown. The tracking processing portion 51 and the buffer memory 54 shown in FIG. 12 are the same as shown in FIG. 2. The tracking processing portion 51, an image deterioration function deriving portion 62 and a filtering processing portion 63 shown in FIG. 12 can be provided in the video signal processing portion 13 of FIG. 1. The image data of the frame images shot by the image sensing portion 11 is fed to the tracking processing portion 51 and the filtering processing portion 63.

The image deterioration function deriving portion 62 (hereinafter, simply referred to as a deriving portion 62) derives, based on the tracking result information stored in the buffer memory 54, an image deterioration function that acts on the frame image in order to have the effects of the vertical follow shot. In the filtering processing portion 63, filtering is performed on the frame image according to the image deterioration function, and thus an output blurred image is generated.

The frame images 201 to 204 shown in FIG. 3 are assumed to be shot as in the first embodiment, and the operations of the deriving portion 62 and the filtering processing portion 63 will be described in detail. As in the first embodiment, the frame image 203 is assumed to be a still image, namely, the reference image (main image) that needs to be shot by the pressing down of the shutter button 26b.

In the deriving portion 62, any one of the frame images is treated as an image to be computed. As shown in FIG. 13, the entire image region of the image to be computed is divided into a plurality of portions in horizontal and vertical directions, and thus a plurality of small blocks are set within the image to be computed. The number of times which the division is performed in the horizontal direction and the number of times which the division is performed in the vertical direction are assumed to be P and Q, respectively (P and Q are integers equal to or more than two.) Each small block is composed of a plurality of pixels arranged two-dimensionally. As symbols that represent the horizontal position and the vertical position of the small block within the image to be computed, symbols p and q are used (p is an integer satisfying an inequality 1≦p≦P, and q is an integer satisfying an inequality 1≦q≦Q). It is assumed that, as the value of p is increased, the horizontal position moves rightward whereas, as the value of q is increased, the vertical position moves downward. A small block whose horizontal position is p and whose vertical position is q is represented by a small block [p, q].

Based on the amount of variation in the size of and the amount of variation in the position of the tracked target region between the adjacent frame images including the reference image, the deriving portion 62 derives an image deterioration function for each of the small blocks. Specifically, for example, since, in this example, the frame image 203 is the reference image, an image deterioration function for each small block can be derived based on the amount of variation in the size of and the amount of variation in the position of the tracked target region between the frame images 202 and 203.

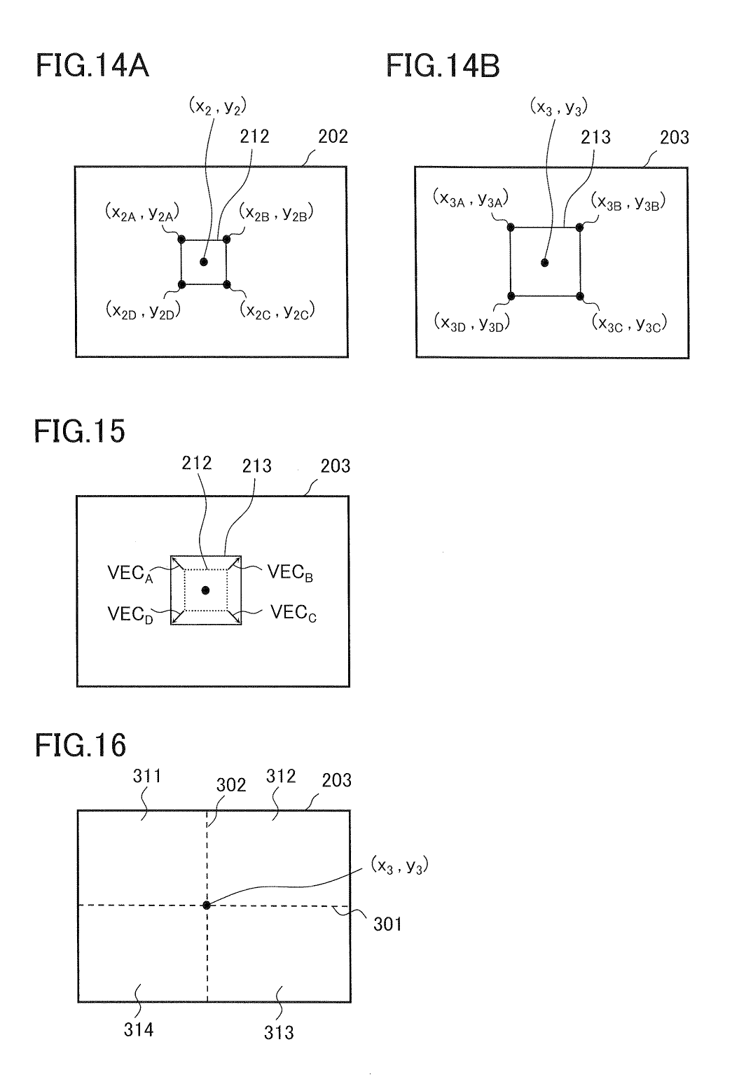

As shown in FIGS. 14A and 14B, tracked target regions 212 and 213 set in the frame images 202 and 203 are assumed to be rectangular, the positions of the four corners of the rectangular which is the outside shape of the tracked target region 212 are represented by (x_{2A}, y_{2A}), (x_{2B}, Y_{2B}), (x_{2C}, y_{2C}) and (x_{2D}, y_{2D}) and the positions of the four corners of the rectangular which is the outside shape of the tracked target region 213 are represented by (x_{3A}, y_{3A}), (x_{3B}, y_{3B}), (x_{3C}, y_{3C}) and (x_{3D}, y_{3D}). It is assumed that x_{2A}=x_{2D}<x_{2B}=x_{2C}, y_{2A}=y_{2B}<y_{2D}=y_{2C}, x_{3A}=x_{3D}<x_{3B}=x_{3C} and y_{3A}=y_{3B}<y_{3D}=y_{3C}. In FIGS. 14A and 14B, a direction pointing from left to right corresponds to a direction in which the x coordinate value increases, and a direction pointing from top to bottom corresponds to a direction in which the y coordinate value increases. The positions of theses corners are also included in the tracking result information.

The deriving portion 62 can derive an image deterioration function for each small block from the positions of the four corners of the tracked target region 212 and the positions of the four corners of the tracked target region 213. When the positions of the four corners of the tracked target region are found, the size of the tracked target region is automatically determined, and thus the positions of the four corners of the tracked target region are said to include information indicating the size of the tracked target region. Hence, the positions of the four corners of the tracked target region 212 and the positions of the four corners of the tracked target region 213 are said to represent not only the amount of variation in the position of the tracked target region between the frame images 202 and 203 but also the amount of variation in the size of the tracked target region between the frame images 202 and 203.

FIG. 15 is a diagram which shows the tracked target region 213 of the frame image 203 and the tracked target region 212 of the frame image 202 such that the tracked target region 213 and the tracked target region 212 are superimposed on the frame image 203. A vector VEC_{A} has the position (x_{2A}, y_{2A}) as its start point and the position (x_{3A}, y_{3A}) as its end point; a vector VEC_{B} has the position (x_{2B}, y_{2B}) as its start point and the position (x_{3B}, y_{3B}) as its end point; a vector VEC_{C} has the position (x_{2C}, y_{2C}) as its start point and the position (x_{3C}, Y_{3C}) as its end point; and a vector VEC_{D} has the position (x_{2D}, y_{2D}) as its start point and the position (x_{3D}, y_{3D}) as its end point.

The deriving portion 62 determines an image deterioration vector for each small block. When an inequality “SIZE₂<SIZE₃” or an inequality “SIZE₃<SIZE₄” holds true, and thus the direction in which the size of the tracked target region is varied around the time of the shooting of the frame image 203 is the direction of increase, an image deterioration vector that points from the center position (x₃, y₃) of the tracked target region 213 to the center position of a small block [p, q] or that points substantially in the same direction as described above is determined for the small block [p, q]. On the other hand, when the direction of the variation is the direction of decrease, an image deterioration vector that points from the center position of the small block [p, q] to the center position (x₃, y₃) of the tracked target region 213 or that points substantially in the same direction as described above is determined for the small block [p, q]. The image deterioration vector for the small block [p, q] is represented by V [p, q].

The size of each image deterioration vector can be determined based on the vector VEC_{A}, the vector VEC_{B}, the vector VEC_{C} and the vector VEC_{D}.

Specifically, for example, in order for the size of the image deterioration vector to be determined, as shown in FIG. 16, the entire image region of the frame image 203 is divided into four portions by a horizontal line 301 and a vertical line 302 that pass through the position (x₃, y₃), and thus the four image regions 311 to 314 are set. The horizontal line 301 and the vertical line 302 are parallel to the horizontal direction and the vertical direction of the frame image 203, respectively. The image regions 311, 312, 313 and 314 respectively include a pixel at the position (x_{3A}, y_{3A}), a pixel at the position (x_{3B}, y_{3B}), a pixel at the position (x_{3C}, y_{3C}) and a pixel at the position (x_{3D}, y_{3D}), and they are parts of the image region of the frame image 203. The image region 311 is located over the horizontal line 301 and on the left side of the vertical line 302; the image region 312 is located over the horizontal line 301 and on the right side of the vertical line 302; the image region 313 is located under the horizontal line 301 and on the right side of the vertical line 302; and the image region 314 is located under the horizontal line 301 and on the left side of the vertical line 302.

For example, the sizes of the image deterioration vectors for small blocks belonging to the image regions 311, 312, 313 and 314 are determined based on the sizes of the vector VEC_{A}, the vector VEC_{B}, the vector VEC_{C} and the vector VEC_{D}, respectively.

One simple way is to make the sizes of the image deterioration vectors for small blocks belonging to the image regions 311, 312, 313 and 314 equal to the sizes of the vectors VEC_{A}, VEC_{B}, VEC_{C} and VEC_{D}, respectively.

Alternatively, for example, as the distance from the position (x₃, y₃) is increased, the size of the image deterioration vector may be increased. Specifically, in a small block belonging to the image region 311, as the distance DIS between the center position of the small block and the position (x₃, y₃) is increased, the size |V| of the image deterioration vector for the small block may be increased with reference to the size |VEC_{A}| of the vector VEC_{A}. For example, the size |V| is determined according to an equation “|V|=k₁×|VEC_{A}|+k₂×|VEC_{A}|×DIS” (where k₁ and k₂ represent predetermined positive coefficients). The same is true for image deterioration vectors for small blocks belonging to the image regions 312 to 314. The sizes of the image deterioration vectors for the small blocks belonging to the image regions 312 to 314 are determined with reference to the sizes of the vectors VEC_{B}, VEC_{C} and VEC_{D}, respectively.

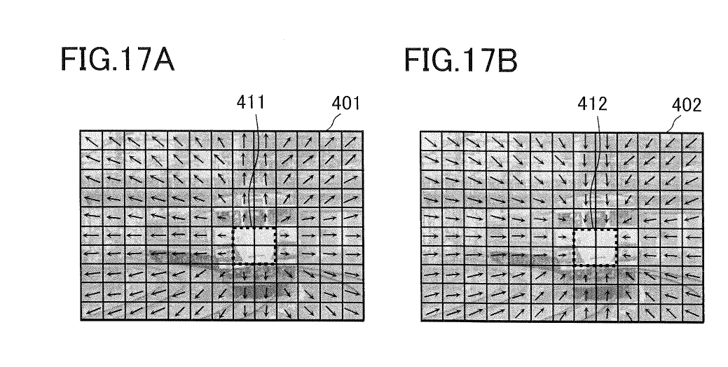

FIG. 17A is a diagram that shows image deterioration vectors acquired when the direction in which the size of the tracked target region is varied around the time of the shooting of the reference image is the direction of increase such that the image deterioration vectors are superimposed on an image 401 which is an example of the reference image. FIG. 17B is a diagram that shows image deterioration vectors acquired when the direction in which the size of the tracked target region is varied around the time of the shooting of the reference image is the direction of decrease such that the image deterioration vectors are superimposed on an image 402 which is an example of the reference image. A rectangular region 411 shown in FIG. 17A is the tracked target region itself of the image 401 or is included in the tracked target region of the image 401; a rectangular region 412 shown in FIG. 17B is the tracked target region itself of the image 402 or is included in the tracked target region of the image 402. As described later, when the output blurred image is generated, it is unnecessary to degrade the images in the regions 411 and 412, and thus image deterioration vectors are not calculated for the regions 411 and 412.

The small blocks for which the image deterioration vectors are not calculated are particularly called subject blocks, and the small blocks other than them are particularly called background blocks. As will be understood from the above description, the image data representing the tracked target is present in the subject blocks. Although the image data of the background is mainly present in the background blocks, the image data representing the end portions of the tracked target can be present in the background blocks near the tracked target region.

Hence, for example, if the tracked target region 213 of the frame image 203 coincides with the combined region of the small blocks [8, 6], [9, 6], [8, 7] and [9, 7] or if the tracked target region 213 includes the combined region and is slightly larger than the combined region, the small blocks [8, 6], [9, 6], [8, 7] and [9, 7] are the subject blocks and the other small blocks are the background blocks.

If it is assumed that, during the exposure of the frame image 203, a point image within a background block [p, q] of the frame image 203 moves (for example, with constant velocity) in the direction of an image deterioration vector V [p, q] by the size of the image deterioration vector V [p, q], the point image is blurred within the frame image 203. This intentionally blurred image is regarded as a deterioration image. Then, the deterioration image can be considered to be an image obtained by deteriorating the frame image 203 by moving the point image based on the image deterioration vector. A function for expressing this deterioration process is a point spread function (hereinafter called a PSF) that is one type of image deterioration function. The deriving portion 62 determines, for each background block, the PSF corresponding to the image deterioration vector as the image deterioration function.

The filtering processing portion 63 performs, with the PSF, a convolution operation on the reference image (frame image 203 in this example) on an individual background block basis to generate an output blurred image. In reality, a two-dimensional spatial domain filter for causing the PSF to act on the reference image is mounted on the filtering processing portion 63, and the deriving portion 62 calculates a filter coefficient of the spatial domain filter according to the PSF on an individual background block basis. The filtering processing portion 63 uses the calculated filter coefficient to perform the spatial domain filtering on the reference image on an individual background block basis. This spatial domain filtering causes the image within the background blocks of the reference image to be degraded, and thus the image within the background blocks of the reference image is blurred as described above. The image resulting from the spatial domain filtering being performed on the reference image (frame image 203 in this example) is output as the output blurred image from the filtering processing portion 63.

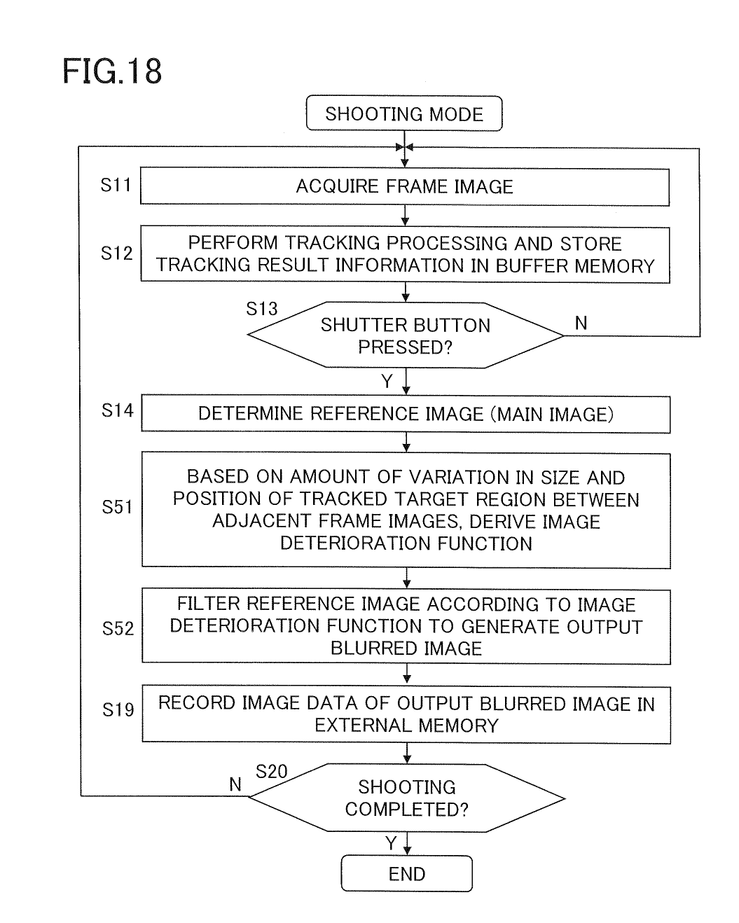

The flow of the operation of generating the output blurred image in the shooting mode will be described with reference to FIG. 18. FIG. 18 is a flowchart showing the flow of this operation. The flowchart of FIG. 18 corresponds to one obtained by replacing steps S15 to S18 within steps S11 to S20 of FIG. 9 in the first embodiment with steps S51 and S52.

Hence, in the shooting mode, the same processing in steps S11 to S14 as in the first embodiment is first performed, and, after the reference image is determined in step S14, the processing in steps S51 and S52 is performed. In step S51, as described above, the deriving portion 62 drives an image deterioration function for each small block based on the amount of variation in the size of and the amount of variation in the position of the tracked target region between the adjacent frame images including the reference image. In the following step S52, the filtering processing portion 63 performs, on the reference image, the filtering corresponding to the image deterioration function derived in step S52 to generate the output blurred image. Thereafter, the image data of the output blurred image is recorded in the external memory 18 in step S19. Here, the image data of the reference image may also be recorded in the external memory 18. After the recording of the image data, if an instruction to complete the shooting is provided, the operation of FIG. 18 is completed whereas, if the instruction is not provided, the process returns to step S11, and the processing in step S11 and the subsequent steps are repeatedly performed (step S20).

As the operation of FIG. 9 is modified to the operations of FIGS. 10 and 11, it is possible to perform, in the reproduction mode, image processing for generating the output blurred image instead of generating the output blurred image in the shooting mode. In this case, preferably, in the shooting mode, the image data of the reference image and the related recorded information necessary to generate the output blurred image from the reference image are related to each other and recorded in the external memory 18, and, in the reproduction mode, the related recorded information is read together with the image data of the reference image from the external memory 18 and they are fed to the deriving portion 62 and the filtering processing portion 63.

The form of the related recorded information is not limited as long as the output blurred image is generated therewith. For example, when the frame image 203 is the reference image, the related recorded information in the second embodiment may be the tracking result information itself of the frame images 202 and 203, may be information representing the image deterioration vector determined from the tracking result information or may be information representing the filter coefficient corresponding to the image deterioration vector.

Even in the second embodiment, it is possible to obtain the same effects as in the first embodiment.

### Third Embodiment

A third embodiment of the present invention will be described. The image processing for generating the output blurred image from the reference image based on the data recorded in the external memory 18 can be achieved by an electronic device different from the image sensing device (the image sensing device is also one type of electronic device.) Examples of the electronic device different from the image sensing device include an image reproduction device (not shown) such as a personal computer that is provided with a display portion similar to the display portion 27 and that can display an image on the display portion.

In this case, as described in the first or second embodiment, in the shooting mode of the image sensing device 1, the image data of the reference image and the related recorded information are recorded together in the external memory 18 such that they are related to each other. On the other hand, for example, the scaling portion 52 and the image combination portion 53 of FIG. 2 are provided in the image reproduction device, and the image data of the reference image and the related recorded information recorded in the external memory 18 are fed to the scaling portion 52 and the image combination portion 53 within the image reproduction device, with the result that it is possible to generate the output blurred image. Alternatively, for example, the deriving portion 62 and the filtering processing portion 63 of FIG. 12 are provided in the image reproduction device, and the image data of the reference image and the related recorded information recorded in the external memory 18 are fed to the deriving portion 62 and the filtering processing portion 63 within the image reproduction device, with the result that it is possible to generate the output blurred image. The output blurred image generated by the image reproduction device can be displayed on the display portion of the image reproduction device.

### Fourth Embodiment

An image sensing device according to a fourth embodiment of the present invention will be described. The overall configuration of the image sensing device of the fourth embodiment is similar to that shown in FIG. 1. Thus, the image sensing device of the fourth embodiment is also represented by the symbol 1. The fourth embodiment corresponds to a variation of the first embodiment. The description of the first embodiment is also applied to what is not particularly included in the description of the fourth embodiment.

The image sensing devices 1 of the fourth embodiment and a fifth embodiment to be described later can generate, from a target input image, an output blurred image that is identical or similar to that obtained in the first embodiment. The target input image refers to a still image that is shot by the image sensing portion 11 through the pressing down of the shutter button 26b or a still image that is specified by the user. The image data of the still image that is the target input image is recorded in the internal memory 17 or the external memory 18, and they can be read when needed. The target input image corresponds to the reference image (main image) of the first embodiment.

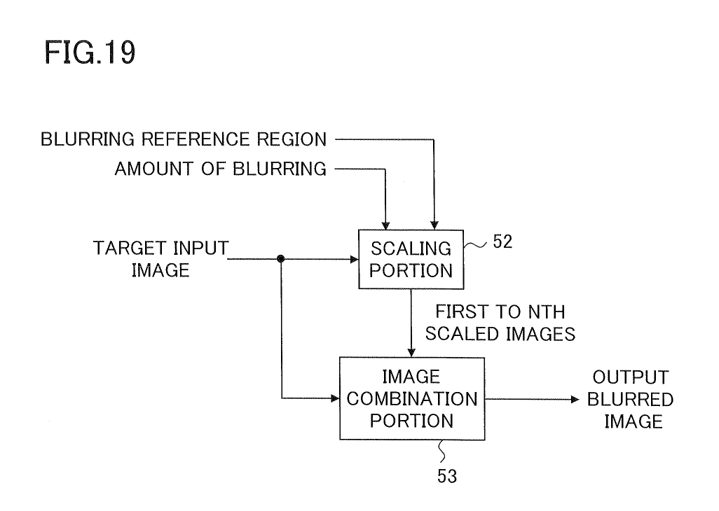

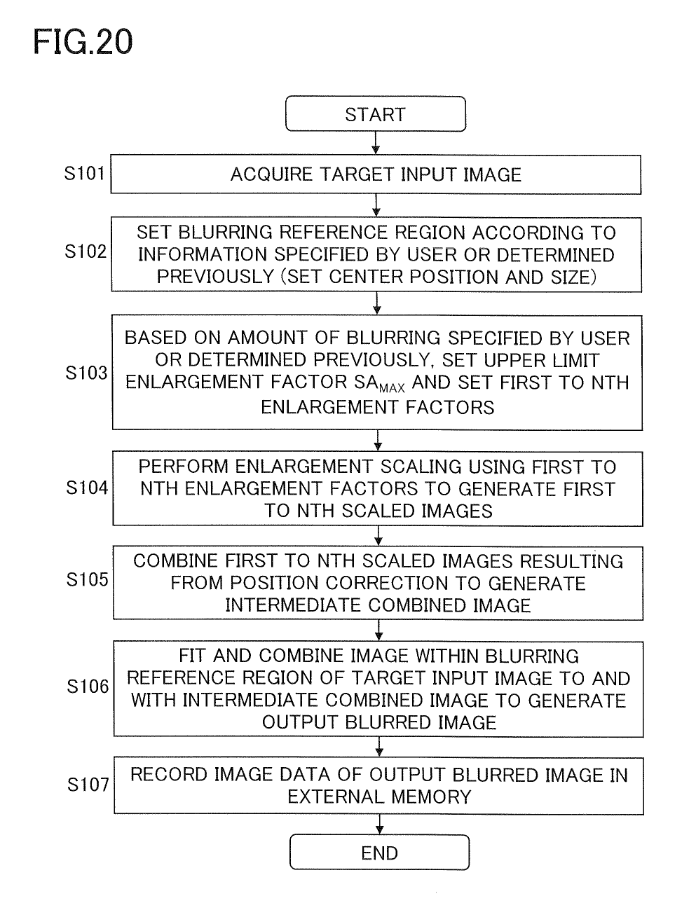

In the image sensing device 1 of the fourth embodiment, the scaling portion 52 and the image combination portion 53 of FIG. 19 are provided; they are the same as shown in FIG. 2. The flow of the operation of generating the output blurred image in the fourth embodiment will be described with reference to FIG. 20. FIG. 20 is a flowchart showing the flow of this operation. The processing in steps S101 to S107 is sequentially performed. The processing in steps S101 to S107 may be performed either in the shooting mode or in the reproduction mode. In the processing in steps S101 to S107, part of the processing may be performed in the shooting mode, and the remaining processing may be performed in the reproduction mode.

In step 5101, the image data of the target input image is first acquired. When step S101 is performed in the shooting mode, the target input image is one frame image obtained by the pressing down of the shutter button 26b immediately before step S101; when step S101 is performed in the reproduction mode, the target input image is one still image read from the external memory 18 or any other recording medium (not shown).

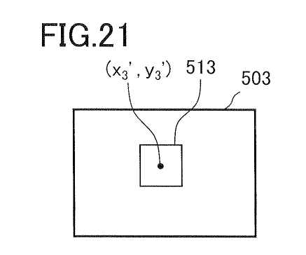

Then, in step S102, the CPU 23 sets a blurring reference region, and the result of the setting is fed to the scaling portion 52 (see FIG. 19). The blurring reference region refers to a part of all the image region (in other words, the entire image region) of the target input image; in step S102, the center position and the size of the blurring reference region are set. The target input image acquired in step S101 is now assumed to be an image 503 of FIG. 21. The target input image 503 can be considered to correspond to the frame image 203 of FIG. 3. In FIG. 21, a rectangular region 513 is the blurring reference region set on the target input image 503, and the center position of the blurring reference region 513 is represented by (x₃′, y₃′).

The user performs a predetermined center position setting operation on the image sensing device 1 and thereby can freely specify the center position (x₃′, y₃′), and performs a predetermined size setting operation on the image sensing device 1 and thereby can freely specify the size (the sizes in the horizontal and vertical directions) of the blurring reference region 513. The center position setting operation and the size setting operation may be either performed on the operation portion 26 or performed on a touch panel when the touch panel is provided in the display portion 27. Since the operation portion 26 is involved in the operation using the touch panel, in this embodiment, the operation on the operation portion 26 is considered to include the operation using the touch panel (the same is true for the other embodiments described above and later.) The user can also perform a predetermined operation on the operation portion 26 and thereby freely specify the shape of the blurring reference region. The blurring reference region 513 does not need to be rectangular. Here, however, the blurring reference region 513 is assumed to be rectangular.

When an operation for specifying the whole or part of the center position, the size and the shape of the blurring reference region 513 is performed on the operation portion 26, it is possible to set the blurring reference region 513 according to the details of the operation. However, the center position of the blurring reference region 513 may be previously fixed (for example, the center position of the target input image 503). Likewise, the size and the shape of the blurring reference region 513 may be previously fixed.

Not only the information for specifying the blurring reference region 513 but also information for specifying the amount of blurring is fed to the scaling portion 52 of FIG. 19. The amount of blurring corresponds to the “amount of variation in the size of the tracked target region” in the first embodiment, and affects the size of blurring on the output blurred image. The user can freely specify the amount of blurring through the operation portion 26. Alternatively, the amount of blurring may be previously fixed. When the amount of blurring is determined, the upper limit enlargement factor SA_{MAX} is automatically determined. Thus, the upper limit enlargement factor SA_{MAX} in the fourth embodiment can be said to be either specified by the user or previously fixed; alternatively, the upper limit enlargement factor SA_{MAX} itself may be regarded as the amount of blurring.

In step S103, the scaling portion 52 sets both the upper limit enlargement factor SA_{MAX} from the amount of blurring that is supplied and the first to nth enlargement factors based on the upper limit enlargement factor SA_{MAX}. The meanings of the upper limit enlargement factor SA_{MAX} and the first to nth enlargement factors are the same as described in the first embodiment.

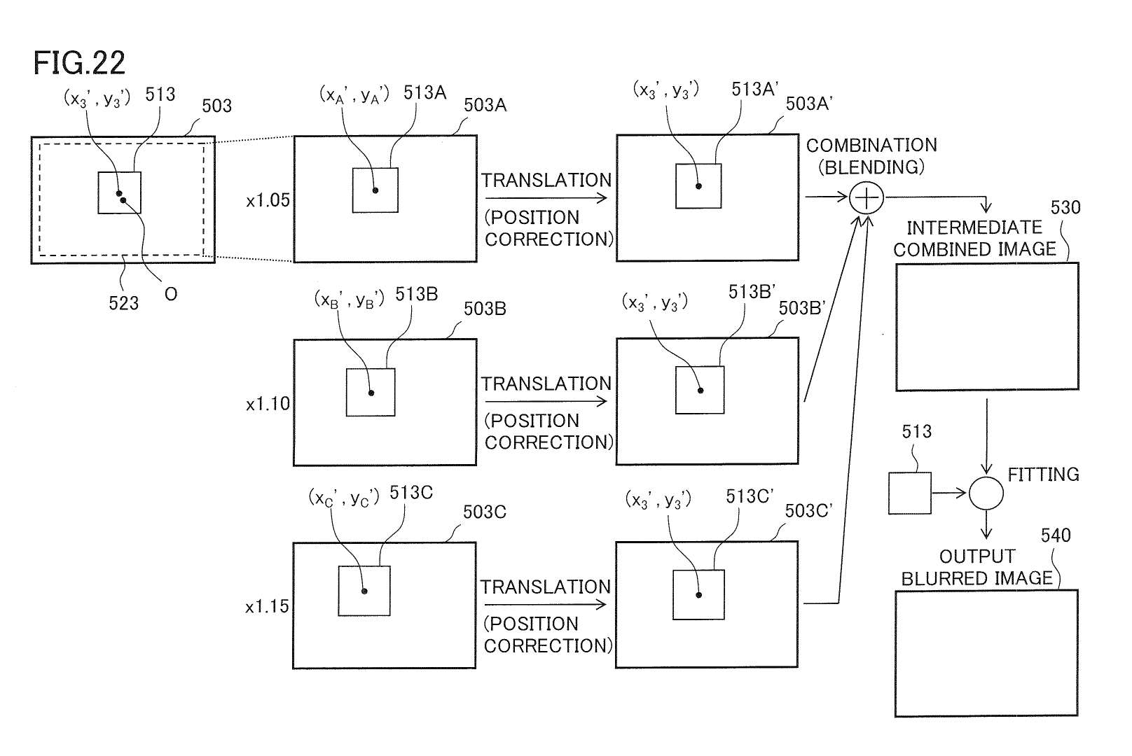

After the setting of the first to nth enlargement factors, an output blurred image 540 based on the target input image 503 is generated by performing processing in steps S104 to S107. This generating method will be described with reference to FIG. 22.

For specific description, it is now assumed that the upper limit enlargement factor SA_{MAX} is equal to or more than 1.15 but less than 1.20. In this case, the scaling portion 52 sets three enlargement factors, namely, 1.05, 1.10 and 1.15. Then, as shown in FIG. 22, the target input image 503 is scaled up by an enlargement factor of 1.05, and thus a scaled image 503A is generated; the target input image 503 is scaled up by an enlargement factor of 1.10, and thus a scaled image 503B is generated; and the target input image 503 is scaled up by an enlargement factor of 1.15, and thus a scaled image 503C is generated.

The enlargement scaling for producing the scaled images 503A, 503B and 503C is performed with reference to the center O of the target input image 503. Specifically, a rectangular extraction frame 523 having its center arranged in the center O is set within the target input image 503, and an image within the extraction frame 523 is scaled up by an enlargement factor of 1.05, with the result that the scaled image 503A is generated. The size of the extraction frame 523 used when the scaled image 503A is generated is (1/1.05) times that of the target input image 503 in each of the horizontal and vertical directions. The scaled images 503B and 503C are generated by scaling up the image within the extraction frame 523 by enlargement factors of 1.10 and 1.15, respectively. The size of the extraction frame 523 used when the scaled image 503B is generated is (1/1.10) times that of the target input image 503 in each of the horizontal and vertical directions; the size of the extraction frame 523 used when the scaled image 503C is generated is (1/1.15) times that of the target input image 503 in each of the horizontal and vertical directions.

In FIG. 22, rectangular regions 513A, 513B and 513C represent the blurring reference regions of the scaled images 503A, 503B and 503C, respectively, and positions (x_{A}′, y_{A}′), (x_{B}′, y_{B}′) and (x_{C}′, y_{C}′) represent the center positions of the blurring reference regions 513A, 513B and 513C, respectively.

The scaled images 503A, 503B and 503C are combined by the image combination portion 53. Before this combination, geometrical transformation is performed on the scaled images to translate the scaled images. This geometrical transformation is called the position correction as in the first embodiment. The position correction is performed by the image combination portion 53; however, it may be performed by the scaling portion 52.

The n scaled images are assumed to be composed of the first to nth scaled images; a scaled image obtained by performing the enlargement scaling using the ith enlargement factor is assumed to be the ith scaled image. Here, i represents an integer equal to or more than one but equal to or less than n, and the (i+1)th enlargement factor is larger than the ith enlargement factor. In the specific example of FIG. 22, the first, second and third enlargement factors are 1.05, 1.10 and 1.15, respectively. The processing for obtaining the images 503A, 503B and 503C as the first to nth scaled images by the enlargement scaling using the first to nth enlargement factors is performed in step S104.

In step S104 or S105, the image combination portion 53 performs the position correction to translate the center position of the blurring reference region on the ith scaled image to the position (x₃′, y₃′). Specifically, the image combination portion 53 performs the position correction on the scaled image 503A to translate a pixel at the position (x_{A}′, y_{A}′) on the scaled image 503A to a pixel at the position (x₃′, y₃′), with the result that the scaled image 503A′ which has undergone the position correction is generated. Likewise, the image combination portion 53 performs the position correction on the scaled image 503B to translate a pixel at the position (x_{B}′, y_{B}′) on the scaled image 503B to the position (x₃′, y₃′), with the result that the scaled image 503B′ which has undergone the position correction is generated; the image combination portion 53 performs the position correction on the scaled image 503C to translate a pixel at the position (x_{C}′, y_{C}′) on the scaled image 503C to the position (x₃′, y₃′), with the result that the scaled image 503C′ which has undergone the position correction is generated. In FIG. 22, rectangular regions 513A′, 513B′ and 513C′ represent the blurring reference regions of the scaled images 503A′, 503B′ and 503C′, respectively.

Although, in the example described above, the geometrical transformation for the position correction is performed after the scaling, the geometrical transformation for the position correction is included in the linear transformation for the scaling, and thus the scaled images 503A′, 503B′ and 503C′ may be generated directly from the target input image 503. When the position (x₃′, y₃′) coincides with the position of the center O, the position correction is unnecessary (in other words, when the position (x₃′, y₃′) coincides with the position of the center O, the images 503A, 503B and 503C are the same as the images 503A′, 503B′ and 503C′, respectively.)

In step S105, in the same manner as in the first embodiment, the image combination portion 53 combines the first to nth scaled images that have undergone the position correction to generate an intermediate combined image. In the specific example of FIG. 22, the scaled images 503A′, 503B′ and 503C′ are combined to form an intermediate combined image 530. A pixel signal at the position (x₃′, y₃′) in the intermediate combined image 530 is generated by simply averaging the pixel signals at the position (x₃′, y₃′) in the images 503A′, 503B′ and 503C′ or by weighted averaging them. The pixel signals at the positions other than the position (x₃′, y₃′) are also generated in the same manner.

In step S106, in the same manner as in the first embodiment, the image combination portion 53 fits and combines the image within the blurring reference region 513 of the target input image 503 to and with the intermediate combined image 530, and thereby generates an output blurred image 540. This fitting and combination is performed with the center position (x₃′, y₃′) on the blurring reference region 513 coinciding with the position (x₃′, y₃′) on the intermediate combined image 530, and an image whose center is the position (x₃′, y₃′) within the intermediate combined image 530 and which is part of the intermediate combined image 530 is replaced with the image within the blurring reference region 513, with the result that the output blurred image 540 is generated. Hence, the image data at the position (x₃′, y₃′) of the target input image 503 is present at the position (x₃′, y₃′) of the output blurred image 540.

The image data of the output blurred image 540 thus generated is recorded in the external memory 18 in step S107. In this case, the image data of the target input image 503 may also be recorded in the external memory 18.

With the processing of FIG. 20 using the enlargement scaling, it is possible to generate the output blurred image in which an object moving close to the image sensing device 1 is in focus and which has the effects of the vertical follow shot; it is also possible to use the reduction scaling instead of the enlargement scaling. In this case, in step S103, instead of the upper limit enlargement factor SA_{MAX} and the first to nth enlargement factors, the lower limit reduction factor SB_{MAX} and the first to nth reduction factors are set based on the amount of blurring; in step S104, the reduction scaling using the first to nth reduction factors is performed, and thus the first to nth scaled images are generated. The method of generating the output blurred image using the reduction scaling which is described in the first embodiment is applied to this embodiment. The user can specify, through the operation portion 26, whether to generate the output blurred image using the enlargement scaling or to generate the output blurred image using the reduction scaling.

Even in this embodiment, the same effects as in the first embodiment can be obtained. Specifically, when the target input image is the image 253 of FIG. 5, it is possible to generate, from the image 253, an output blurred image equivalent to the output blurred image 290 of FIG. 8. Furthermore, in this embodiment, it is possible to generate this type of output blurred image from an image per sheet.

### Fifth Embodiment

A fifth embodiment of the present invention will be described. The overall configuration of an image sensing device of the fifth embodiment is similar to that shown in FIG. 1. Thus, the image sensing device of the fifth embodiment is also represented by the symbol 1. The description of the first, second and fourth embodiments is also applied to what is not particularly included in the description of the fifth embodiment.

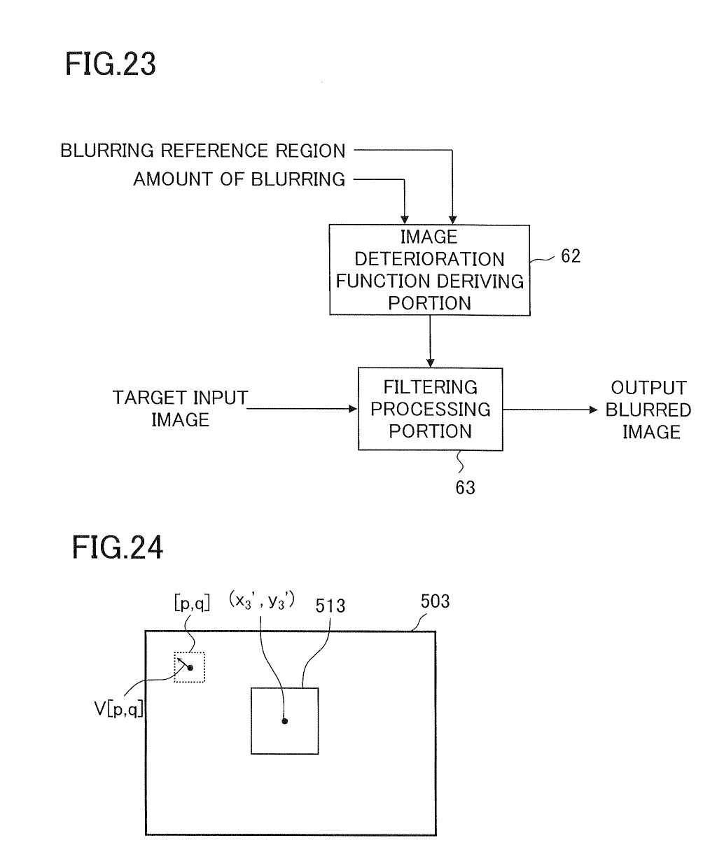

The image sensing device 1 of the fifth embodiment utilizes a method similar to that described in the second embodiment to generate the output blurred image from the target input image. The image sensing device 1 of the fifth embodiment is provided with the image deterioration function deriving portion 62 and the filtering processing portion 63 of FIG. 23; they are the same as shown in FIG. 12.

In the fifth embodiment, the information for specifying the blurring reference region and the amount of blurring, which are described in the fourth embodiment, is fed to the deriving portion 62. The method of setting the blurring reference region and the amount of blurring is the same as described in the fourth embodiment. For specific description, as in the specific example of the fourth embodiment, it is now assumed that a target input image and a blurring reference region are the target input image 503 and the blurring reference region 513, respectively, and that the center position of the blurring reference region 513 is the position (x₃′, y₃′) (see FIG. 21).

As described in the second embodiment, a plurality of small blocks are set within all the image regions of the target input image 503, which is an image to be computed (see FIG. 13). The deriving portion 62 derives an image deterioration function for each small block based on the information for specifying the blurring reference region and the amount of blurring. As shown in FIG. 24, an image deterioration vector V [p, q], from which an image deterioration function for a small block [p, q] is originated, points from the position (x₃′, y₃′) to the center position of the small block [p, q]. Hence, when the image 401 of FIG. 17A is the target input image 503, a plurality of image deterioration vectors as represented by a plurality of arrows of FIG. 17A are derived. Here, image deterioration vectors are not derived for the rectangular region 411. When the image 401 of FIG. 17A is the target input image 503, the rectangular region 411 is either the blurring reference region 513 itself or a region included in the blurring reference region 513.

As in the second embodiment, the small blocks for which the image deterioration vectors are not calculated are particularly called subject blocks, and the small blocks other than them are particularly called background blocks. Hence, for example, if the blurring reference region 513 of the target input image 503 coincides with the combined region of the small blocks [8, 6], [9, 6], [8, 7] and [9, 7] or if the blurring reference region 513 includes the combined region and is slightly larger than the combined region, the small blocks [8, 6], [9, 6], [8, 7] and [9, 7] are the subject blocks and the other small blocks are the background blocks. The combined region of all the background blocks corresponds to the background region.

The size of an image deterioration vector for each background block can be determined based on the amount of blurring that is set. As the amount of blurring that is set is increased, the size of the image deterioration vector for each background block is increased.

In this case, the sizes of the image deterioration vectors in all the background blocks can be set equal to each other. Alternatively, as the distance from the position (x₃′, y₃′) is increased, the size of the image deterioration vector may be increased. Specifically, as a distance DIS′ between the center position of a background block and the position (x₃′, y₃′) is increased, the size of the image deterioration vector of the background block may be increased with reference to the amount of blurring that is set. Yet alternatively, when the amount of blurring is specified by the user for each background block using the operation portion 26, the size of the image deterioration vector may be determined for each background block based on the amount of blurring in each background block.

The deriving portion 62 determines, for each background block, the PSF corresponding to the image deterioration vector as the image deterioration function; the filtering processing portion 63 performs, with the PSF, a convolution operation on the target input image 503 on an individual background block basis to generate the output blurred image. The method of generating, from the target input image, the output blurred image using the image deterioration vector for each background block is the same as the method of generating, from the reference image, the output blurred image using the image deterioration vector for each background block, which is described in the second embodiment. When the description of the second embodiment is applied to this embodiment, the frame image 203 or the reference image in the second embodiment is preferably regarded as the target input image 503.

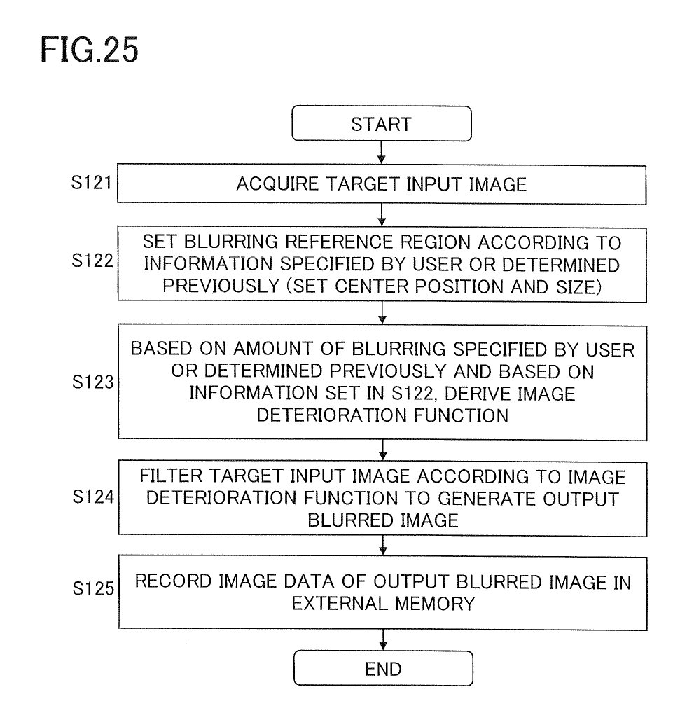

The flow of the operation of generating the output blurred image in the fifth embodiment will be described with reference to FIG. 25. FIG. 25 is a flowchart showing the flow of this operation. The processing in steps S121 to S125 is sequentially performed. The processing in steps S121 to S125 may be performed either in the shooting mode or in the reproduction mode. In the processing in steps S121 to S125, part of the processing may be performed in the shooting mode, and the remaining processing may be performed in the reproduction mode.

The processing in steps S121 and S122 is the same as that in steps S101 and S102 shown in FIG. 20. Specifically, in step 5121, the image data of the target input image is acquired, and, in step S122, the CPU 23 sets the blurring reference region based either on information specified by the user through the operation portion 26 or on information previously fixed. The items that are set here include the center position, the size and the shape of the blurring reference region.

In step S123, the deriving portion 62 drives an image deterioration function for each background block based on the amount of blurring specified by the user through the operation portion 26 or the amount of blurring previously fixed and based on the information set in step S122. In the following step or step S124, the filtering processing portion 63 performs, on the target input image, the filtering corresponding to the image deterioration function derived in step S123 to generate the output blurred image. Thereafter, the image data of the output blurred image is recorded in the external memory 18 in step S125. Here, the image data of the target input image may also be recorded in the external memory 18.

Although, in the specific example described above, the output blurred image (hereinafter called a first output blurred image) in which the object moving close to the image sensing device 1 is in focus is generated, it is possible to generate, in the same manner as described above, an output blurred image (hereinafter called a second output blurred image) in which the object moving away from the image sensing device 1 is in focus. When the second output blurred image is generated, the image deterioration vector of the background block is preferably directed in the opposite direction from that used when the first output blurred image is generated. The user can specify, with the operation portion 26, which of the first and second output blurred images is generated.

As described above, the direction of the image deterioration vector for the background block is set parallel to the direction intersecting the position of the blurring reference region and the position of the background block. Thus, the output blurred image is so blurred as to appear to flow from or into the blurring reference region. In this way, it is possible to obtain the effects of the vertical follow shot for causing the object within the blurring reference region to appear to move. In short, even in the fifth embodiment, it is possible to obtain the same effects as in the fourth embodiment.

### Sixth Embodiment

A sixth embodiment of the present invention will be described. The image processing for generating the output blurred image from the target input image can be achieved by an electronic device different from the image sensing device (the image sensing device is also one type of electronic device.) Examples of the electronic device different from the image sensing device include an image reproduction device (not shown) such as a personal computer that is provided with a display portion similar to the display portion 27 and that can display an image on the display portion.

For example, the scaling portion 52 and the image combination portion 53 of FIG. 19 are provided in the above-described image reproduction device, and the image data of the target input image recorded in the external memory 18 is fed to the scaling portion 52 and the image combination portion 53 within the image reproduction device, and thus it is possible to generate the output blurred image. Alternatively, for example, the deriving portion 62 and the filtering processing portion 63 of FIG. 23 are provided in the above-described image reproduction device, and the image data of the target input image recorded in the external memory 18 is fed to the deriving portion 62 and the filtering processing portion 63 within the image reproduction device, and thus it is possible to generate the output blurred image. It is possible to display the output blurred image generated by the image reproduction device on the display portion of the image reproduction device. When an operation portion equivalent to the operation portion 26 is provided in the above-described image reproduction device, the user can specify the burring reference region, the amount of blurring and the like through the operation portion.

The specific values discussed in the above description are simply examples, and it is needless to say that they can be changed to various values.

The image sensing device 1 of FIG. 1 can be formed either with hardware or a combination of hardware and software. In particular, the functions of the tracking processing portion 51, the scaling portion 52, the image combination portion 53, the deriving portion 62 and the filtering processing portion 63 can be achieved with hardware alone, software alone or a combination of hardware and software. The whole or part of these functions is formed with a program, and the program is run on a program execution device (for example, a computer), with the result that the whole or part of these functions may be achieved.

What is claimed is:

1. An image processing device which uses a main image and a sub-image shot at different times to generate an output image, the image processing device comprising:
a subject detection portion which detects a specific subject from each of the main image and the sub-image and detects a position and a size of the specific subject on the main image and a position and a size of the specific subject on the sub-image,
wherein the image processing device generates the output image by causing the main image to be blurred based on a variation in the position of and a variation in the size of the specific subject between the main image and the sub-image.

2. The image processing device of claim 1, further comprising:
a scaling portion which performs, based on the variation in the size of the specific subject between the main image and the sub-image, scaling using a plurality of enlargement factors and a plurality of reduction factors on the main image to generate a plurality of scaled images; and
an image combination portion which combines, based on the position of the specific subject on the main image and the position of the specific subject on the sub-image, the plurality of scaled images, and which applies a result of the combination to the main image to generate the blurring.

3. The image processing device of claim 1,
wherein the image processing device divides an entire image region of the main image into a subject region where image data of the specific subject is present and a background region, and causes, based on the variation in the position of and the variation in the size of the specific subject between the main image and the sub-image, an image within the background region of the main image to be blurred, and thus generates the output image.

4. The image processing device of claim 2,
wherein the image combination portion combines, based on the position of the specific subject on the main image and the position of the specific subject on the sub-image, the plurality of scaled images, and applies a result of the combination to an image within a background region of the main image to generate the blurring.

5. The image processing device of claim 2,
wherein, when it is determined that, based on the variation in the size of the specific subject between the main image and the sub-image, the size of the specific subject on the image increases with time, the scaling portion uses the plurality of enlargement factors to generate the plurality of scaled images, or when it is determined that, based on the variation in the size of the specific subject between the main image and the sub-image, the size of the specific subject on the image decreases with time, the scaling portion uses the plurality of reduction factors to generate the plurality of scaled images.

6. The image processing device of claim 2,
wherein the scaling portion derives an upper limit enlargement factor or a lower limit reduction factor based on an amount of variation in the size of the specific subject between the main image and the sub-image, and, when the upper limit enlargement factor is derived, a plurality of different scaling factors ranging from an equal scaling factor to the upper limit enlargement factor are set as the plurality of enlargement factors whereas, when the lower limit reduction factor is derived, a plurality of different scaling factors ranging from the equal scaling factor to the lower limit reduction factor are set as the plurality of reduction factors.

7. The image processing device of claim 6,
wherein, when the upper limit enlargement factor is derived, first to nth enlargement factors (where n represents an integer of two or more) are set as the plurality of enlargement factors,
an (i+1)th enlargement factor (where i represents an integer of one or more but (n−1) or less) is larger than an ith enlargement factor,
the subject detection portion detects a center position of a subject region on the main image and a center position of a subject region on the sub-image as the position of the specific subject on the main image and the position of the specific subject on the sub-image, respectively,
the scaling portion performs the scaling using the first to nth enlargement factors to generate first to nth scaled images as the plurality of scaled images and
the image combination portion performs position correction on the first to nth scaled images and then combines the first to nth scaled images such that
a center position of the specific subject on the first scaled image coincides with a center position of the specific subject on the sub-image which is shot before the shooting of the main image,
a center position of the specific subject on the nth scaled image coincides with a center position of the specific subject on the main subject and
center positions of the specific subject on the second to the (n−1)th scaled images are arranged between the center position of the specific subject on the sub-image and the center position of the specific subject on the main image.

8. The image processing device of claim 6,
wherein, when the lower limit reduction factor is derived, first to nth reduction factors (where n represents an integer of two or more) are set as the plurality of reduction factors,
an (i+1)th reduction factor (where i represents an integer of one or more but (n−1) or less) is smaller than an ith reduction factor,
the subject detection portion detects a center position of a subject region on the main image and a center position of a subject region on the sub-image as the position of the specific subject on the main image and the position of the specific subject on the sub-image, respectively,
the scaling portion performs the scaling using the first to nth reduction factors to generate first to nth scaled images as the plurality of scaled images and
the image combination portion performs position correction on the first to nth scaled images and then combines the first to nth scaled images such that
a center position of the specific subject on the first scaled image coincides with a center position of the specific subject on the sub-image which is shot before the shooting of the main image,
a center position of the specific subject on the nth scaled image coincides with a center position of the specific subject on the main subject and
center positions of the specific subject on the second to the (n−1)th scaled images are arranged between the center position of the specific subject on the sub-image and the center position of the specific subject on the main image.

9. The image processing device of claim 1, further comprising:
an image deterioration function deriving portion which divides a background region of the main image into a plurality of small blocks, and derives, based on the variation in the position of and the variation in the size of the specific subject between the main image and the sub-image, for each of the small blocks, an image deterioration function that causes an image within the small block to be blurred; and
a filtering processing portion which performs, for each of the small blocks, filtering on the image within the small block according to the image deterioration function to generate the output image,
wherein the background region is an image region other than an image region where image data of the specific subject is present.

10. An image processing device which causes an input image to be blurred to generate an output image, the image processing device comprising:
a scaling portion which performs scaling using a plurality of enlargement factors or a plurality of reduction factors on the input image to generate a plurality of scaled images; and
an image combination portion which combines the plurality of scaled images, and applies a result of the combination to the input image to generate the blurring.

11. The image processing device of claim 10,
wherein the image combination portion combines, with an image within a reference region of the input image, a combination image obtained by combining the plurality of scaled images and thereby generates the output image, and a position of the reference region on the input image is either specified through an operation portion or determined previously.

12. The image processing device of claim 10,
wherein the scaling portion sets the plurality of enlargement factors or the plurality of reduction factors based on an amount of blurring that is either specified through an operation portion or determined previously.

13. An image processing device which causes an input image to be blurred to generate an output image, the image processing device comprising:
an image deterioration function deriving portion which divides a background region of the input image into a plurality of small blocks, and derives, for each of the small blocks, an image deterioration function that causes an image within the small block to be blurred; and
a filtering processing portion which performs, for each of the small blocks, filtering on the image within the small block according to the image deterioration function to generate the output image,
wherein an entire image region of the input image is composed of the background region and a reference region, and the image deterioration function for each of the small blocks corresponds to an image deterioration vector whose direction intersects a position of the reference region and the small block.

14. The image processing device of claim 13,
wherein the position of the reference region on the input image is either specified through an operation portion or determined previously.

15. An image sensing device comprising:
the image processing device of claim 1; and
an image sensing portion which shoots the main image and the sub-image that are fed to the image processing device.

16. An image sensing device comprising:
the image processing device of claim 10; and
an image sensing portion which shoots the input image that is fed to the image processing device.

17. An image sensing device comprising:
the image processing device of claim 13; and
an image sensing portion which shoots the input image that is fed to the image processing device.

18. An image reproduction device comprising:
the image processing device of claim 1; and
a display portion which displays the output image generated by the image processing device.

19. An image reproduction device comprising:
the image processing device of claim 10; and
a display portion which displays the output image generated by the image processing device.

20. An image reproduction device comprising:
the image processing device of claim 13; and
a display portion which displays the output image generated by the image processing device.
